(19) United States
(12) Patent Application Publication
(10) Pub. No.: US 2019/0202991 A1
(43) Pub. Date: Jul. 4, 2019

(54) ENERGY CONVERSION DEVICES INCLUDING STABLE IONENES

(71) Applicant: Simon Fraser University, Burnaby (CA)

(72) Inventors: Steven Holdcroft, Pitt Meadows (CA); Benjamin Britton, Vancouver (CA); Andrew Wright, Mountain View, CA (US)

(73) Assignee: Simon Fraser University, Burnaby, BC (CA)

(21) Appl. No.: 16/098,827

(22) PCT Filed: May 1, 2017
(86) PCT No.: PCT/CA2017/050529

§ 371 Date: Nov. 2, 2018

Related U.S. Application Data
(60) Provisional application No. 62/330,720, filed on May 2, 2016.

(51) Int. Cl. C08G 73/18; H01M 4/86; H01M 4/92; H01M 4/96; H01M 8/103; H01M 8/1088; H01M 8/1004; H01M 8/04089; H01M 8/04291; H01M 8/04228; H01M 8/04701; C25B 1/10; C25B 9/10; H01M 8/04303

(52) U.S. Cl. CPC C08G 73/18; H01M 2008/1095; H01M 4/926; H01M 4/96; H01M 8/103; H01M 8/1088; H01M 8/1004; H01M 8/04089; H01M 8/04291; H01M 8/04228; H01M 8/04701; C25B 1/10; C25B 9/10; H01M 8/04303; H01M 4/8668

(57) ABSTRACT

Described herein are stable hydroxide ion-exchange polymers and devices including the stable hydroxide ion-exchange N polymers. The polymers include ionenes, which are polymers that contain ionic amines in the backbone. The polymers are alcohol-soluble and water-insoluble. The polymers have a water uptake and an ionic conductivity that are correlated to a degree of N-substitution. Methods of forming the polymers and membranes including the polymers are also provided. The polymers are suitable, for example, for use as ionomers in catalyst layers for fuel cells and electrolyzers.

### CROSS-REFERENCE TO RELATED APPLICATION

This application claims the benefit of U.S. Provisional Application No. 62/330,720, filed May 2, 2016, the disclosure of which is incorporated herein by reference in its entirety.

### BACKGROUND

Polymer-based anion exchange membrane (AEM) fuel cells (AEMFCs) are of growing academic and technical interest as they have the potential to operate with non-platinum group electrocatalysts, thus significantly lowering manufacturing costs. AEMs also have great potential for use in water electrolyzers, water purification devices, redox-flow batteries, and biofuel cells. A goal of AEM research is to increase their stability under high pH and high temperature conditions. Several cationic moieties have been evaluated for their hydroxide stability, including guanidinium, 1,4-diazabicyclo[2.2.2]octan (DABCO), imidazolium, pyrrolidinium, sulfonium, phosphonium, and ruthenium-based cations. However, these generally degrade over relatively short periods of time when exposed to a combination of high pH and temperature. The majority of reported AEMs are derived from commercial and traditional polymer backbones (polystyrene and polyethersulfones/ketones) due to the low cost, ease of preparation, and availability, but these may also contain backbone functionality that are susceptible to degradation that exacerbates instability.

One class of polymers that contains cationic moieties along the backbone, as opposed to the previously mentioned pendant examples, are the alkylated poly(benzimidazoles), wherein the integrity of the polymer backbone is directly related the stability of the benzimidazolium group. Without wishing to be bound by theory, it is believed that the number of possible degradation routes for poly(benzimidazolium) are few. It was originally reported that degradation of methylated poly(benzimidazolium) was the result of ring opening, initiated by hydroxide attack on the C₂-position. Chemical degradation of membranes is accompanied by increased brittleness and deterioration of the membrane. The probability of hydroxide attack may be lowered by increasing the electron density at the C₂-position using electron-donating groups and/or by increasing the distance between the benzimidazolium repeat units. A strategy leading to stabilization of the benzimidazolium is to introduce steric hindrance around the C₂-position by way of proximal methyl groups. A polymeric material that has been demonstrated to exhibit exceptional chemical stability is based on poly[2,2′-(2,2″,4,4″,6,6″-hexamethyl-p-terphenyl-3,3″-diyl)-5,5′-bibenzimidazole] (HMT-PBI).

The long-term in situ stability of a cationic polymer that can act as both an anion-exchange membrane and ionomer would represent a significant advance in AEMFC and water electrolysis research. Such a material could serve as a benchmark material, allowing the effect of radical species on AEMs to be probed, for example, so as to form the basis for the development of accelerated durability tests. Furthermore, a chemically-stable, high-conductivity anion-exchange ionomer that is resistant to CO₂ impurities is required to assess the function and stability of novel alkaline catalysts. While AEMFC stability has been shown to some extent at 50° C., higher temperatures are required to increase hydroxide conductivity and improve CO₂ tolerance. Additionally, a benchmark AEM material would require its synthesis to be scalable as well as possess a wide-range of properties, such as good mechanical properties, high anionic conductivity, low water uptake, low dimensional swelling, and high chemical stability.

Thus, membranes including a cationic polymer that can act in both an anion-exchange membrane and ionomer are needed. The cationic polymer should present a chemically-stable, high-conductivity anion-exchange ionomer that is resistant to CO₂ impurities; should possess good mechanical properties, high anionic conductivity, low water uptake, low dimensional swelling, and high chemical stability; and should be amenable to large scale synthesis. The present disclosure seeks to fulfill these needs and provides further advantages.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, the present disclosure features a catalyst-coated membrane, including:

(a) a film comprising a random copolymer of Formula (I)

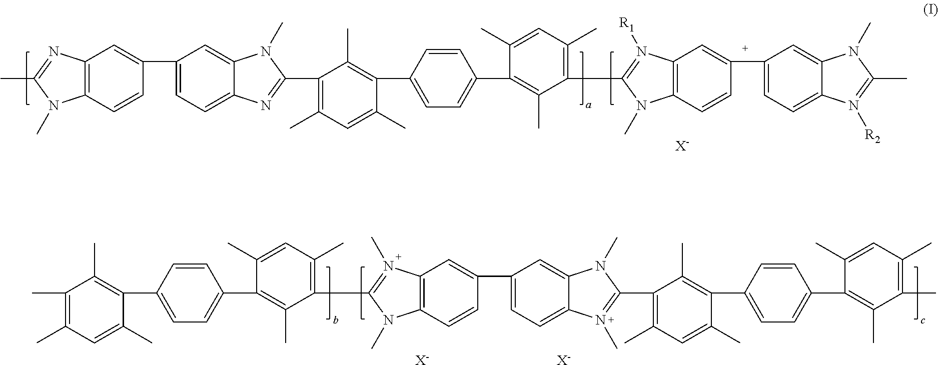

wherein
X⁻ is an anion selected from iodide, bromide, chloride, fluoride, hydroxide, carbonate, bicarbonate, sulfate, tetrakis(3,5-bis(trifluoromethyl)phenyl)borate, bis(trifluoromethane)sulfonamide, and any combination thereof, wherein X⁻ counterbalances a positive charge in the polymer;
R₁ and R₂ are each independently selected from absent and methyl,
   provided that R₁ and R₂ are not both absent, or both methyl;
   provided that when one of R₁ or R₂ is methyl, the other is absent; and
   provided that when R₁ or R₂ is methyl, the nitrogen to which the methyl is connected to is positively charged,

a, b, and c are mole percentages, wherein
a is from 0 mole % to 45 mole %,
b+c is 55 mole % to 100 mole %,
b and c are each more than 0%, and
a+b+c=100%, and

(b) a catalyst coating on the film, the catalyst coating including from 5% to 35% by weight of the polymer of Formula (I) and from 65% to 95% by weight of a metal or non-metal catalyst.

In another aspect, the present disclosure features a fuel cell, including a catalyst-coated membrane above, wherein the catalyst-coated membrane has two sides, one side of the catalyst-coated membrane is a cathode, and the other side of the catalyst-coated membrane is an anode.

In yet another aspect, the present disclosure features a method of operating a fuel cell including a catalyst-coated membrane above, the method including (a) conditioning the fuel cell by supplying hydrogen to the anode, and oxygen and water to the cathode, and operating the fuel cell to generate electrical power and water at a potential of 1.1 V to 0.1 V and at a temperature of 20° C. to 90° C., until the fuel cell reaches at least 90% of peak performance; and (b) continuing supplying hydrogen to the anode and oxygen and water to the cathode, and operating the fuel cell at a potential of 1.1 V to 0.1 V and a temperature of 20° C. to 90° C. It is understood that unless otherwise stated, operation of a device (e.g., a fuel cell, a water electrolyzer, etc.) including the catalyst-coated membrane is at 1 atm.

In yet another aspect, the present disclosure features a method of making a fuel cell, including (a) pre-conditioning a catalyst-coated membrane above by contacting the catalyst-coated membrane with an aqueous hydroxide solution for at least 1 hour to provide a pre-conditioned catalyst-coated membrane; and (b) incorporating the pre-conditioned catalyst-coated membrane into a fuel cell.

In yet another aspect, the present disclosure features a method of making a fuel cell, including (a) incorporating a catalyst-coated membrane above into a fuel cell; and (b) pre-conditioning the fuel cell by contacting the catalyst-coated membrane with an aqueous hydroxide solution for at least 1 hour to provide a pre-conditioned catalyst-coated membrane.

In yet another aspect, the present disclosure features a water electrolyzer, including a catalyst-coated membrane above, wherein the catalyst-coated membrane has two sides: one side of the catalyst-coated membrane is a cathode, and the other side of the catalyst-coated membrane is an anode.

In yet another aspect, the present disclosure features a method of operating a water electrolyzer above, including (a) providing water or an aqueous hydroxide electrolyte solution at 20° C. to 80° C. to the anode, the cathode, or both the anode and the cathode of the water electrolyzer; and (b) operating the water electrolyzer to generate hydrogen, oxygen, and water.

In yet another aspect, the present disclosure features a method of making an electrolyzer (e.g., a water electrolyzer), including (a) incorporating a catalyst-coated membrane above into the electrolyzer; and (b) pre-conditioning the electrolyzer by contacting the catalyst-coated membrane with an aqueous hydroxide solution for at least 1 hour to provide a pre-conditioned catalyst-coated membrane.

In yet a further aspect, the present disclosure features a method of making an electrolyzer (e.g., a water electrolyzer), including (a) pre-conditioning a catalyst-coated membrane above by contacting the catalyst-coated membrane with an aqueous hydroxide solution for at least 1 hour to provide a pre-conditioned catalyst-coated membrane; and (b) incorporating the pre-conditioned catalyst-coated membrane into an electrolyzer.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a chemical structure of 50-100% degree of methylation (dm) of an embodiment of a random (“ran”) polymer of the present disclosure in its iodide form, where constitutional units are between square brackets and are randomly distributed in the polymer chain, and mole percentages are indicated by a, b, an c (i.e., HMT-PMBI (I—), where dm represents the degree of methylation).

FIG. 2 is a schematic representation of an embodiment of an anion exchange membrane fuel cell (AEMFC) of the present disclosure.

FIG. 3 is a schematic representation of an embodiment of a water electrolyzer of the present disclosure.

FIG. 4 is a graph showing mechanical properties of a membrane including an embodiment of a polymer of the present disclosure, at 89% dm in either the as-cast form (IF, dry) or chloride-exchanged wet and dry forms.

FIG. 5A is a graph showing measured electrochemical impedance spectroscopy (EIS) of an embodiment of a polymer of the present disclosure, at 89% dm (initially in OH⁻ form), at 95% RH and 30° C. in air over time.

FIG. 5B is a graph of ionic conductivity as measured by electrochemical impedance spectroscopy of an embodiment of a polymer of the present disclosure, at 89% dm (initially in OH⁻ form) at 95% RH and 30° C. in air over time, where the inset shows the expanded, 0-60 min, region.

FIG. 6A is an Arrhenius plot of ion conductivity of an embodiment of a polymer of the present disclosure, at 89% dm in mixed carbonate form at various temperatures and relative humidities (RH), in air.

FIG. 6B is a plot of the calculated activation energy of an embodiment of a polymer of the present disclosure, at 89% dm in mixed carbonate form at various relative humidities.

FIG. 7A is a graph showing volume dimensional swelling (Sᵥ) versus water uptake (Wᵤ), including a dashed trendline which excludes K₂CO₃, Na₂SO₄, and KF, for an embodiment of a polymer of the present disclosure, at 89% dm.

FIG. 7B is a graph showing directional dimensional swelling (Sₓ, S_{y}, or S_{z}) for an embodiment of a polymer of the present disclosure, at 89% dm, after being soaked in various 1 M ionic solutions and washed with water. Sₓ and S_{y} represent in-plane swelling in x and y directions, respectively. S_{z} represents an out-of-plane swelling.

FIG. 8A is a graph showing the measured chloride ion conductivity of a of a membrane including an embodiment of a polymer of the present disclosure, at 89% dm, after 7 days of soaking in 2 M KOH at various temperatures. Membranes were first reconverted to the chloride form for conductivity measurements and then the remaining benzimidazolium was determined from their ¹H NMR spectra. The open diamonds refer to the initial samples.

FIG. 8B is a graph showing relative percent of benzimidazolium remaining in a membrane including an embodiment of a polymer of the present disclosure, at 89% dm, after 7 days of soaking in 2 M KOH at various temperatures. Membranes were first reconverted to the chloride form for conductivity measurements and then the benzimidazolium remaining was determined from their ¹H NMR spectra. The open diamonds refer to the initial samples.

FIG. 8C is a graph showing the measured chloride ion conductivity of a membrane including an embodiment of a polymer of the present disclosure, at 89% dm, after 7 days immersion in NaOH solutions of increasing concentration at 80° C. Membranes were first reconverted to the chloride form for conductivity measurements and then the benzimidazolium remaining was determined from their 1H NMR spectra. The open diamonds refer to the initial samples.

FIG. 8D is a graph showing the relative percent of benzimidazolium remaining in a membrane including an embodiment of a polymer of the present disclosure, at 89% dm, after 7 days of immersion in NaOH solutions of increasing concentration at 80° C. Membranes were first reconverted to the chloride form for conductivity measurements and then the benzimidazolium remaining was determined from their ¹H NMR spectra. The open diamonds refer to the initial samples.

FIG. 9 is a graph showing measured applied potentials over time for an AEMFC incorporating an embodiment of a membrane and ionomer of the present disclosure, operated at 60° C., with H₂ being supplied to the anode, at the current density shown. At 60 h, the AEMFC was shut-down, left idle for 5 days at room temperature, and restarted back to 60° C. Between 70-91 h, the cathode was run using air (CO₂-containing); otherwise, it was operated with O₂.

FIG. 10A is a graph showing AEMFC polarization and power density curves after various operational times for a device including an embodiment of a polymer of the present disclosure, operated at 60° C. and with H₂/O₂ supplied to anode/cathode unless otherwise noted, specifically, FIG. 10 A shows the performance before, during, and after switching the cathode supply from O₂ (51 hours (“h”)) to air (75 h) and then back to O₂ (94 h),

FIG. 10B is a graph showing AEMFC polarization and power density curves after various operational times for a device including an embodiment of a polymer of the present disclosure, operated at 60° C. and with H₂/O₂ supplied to anode/cathode unless otherwise noted, specifically, FIG. 10B shows the power density at 0, 51, and 94 h,

FIG. 10C is a graph showing AEMFC polarization and power density curves after various operational times for a device including an embodiment of a polymer of the present disclosure, operated at 60° C. and with H₂/O₂ supplied to anode/cathode unless otherwise noted, specifically, FIG. 10C shows the variable temperature performance after an initial 109 h of operation at 60° C.

FIG. 11 is a graph showing AEMFC performance of devices including an embodiment of a polymer of the present disclosure, or of a comparative polymer (FAA-3), operated under zero backpressure at 60° C. and with H₂/O₂ at 100% RH.

FIG. 12 is a graph showing measured potential over time for a water electrolysis test of devices including a comparative polymer (FAA-3, at 20 mA cm⁻²) or an embodiment a of a polymer of the present disclosure (25 mA cm⁻²), where the flowing electrolyte was 1 M KOH at 60° C. for up to 195 h, at which point the still-functional electrolyzer was shut down. At 144 h, the current was stopped, the cell was allowed to re-condition with the same electrolyte and temperature, and then restarted.

### DETAILED DESCRIPTION

Described herein are stable hydroxide ion-exchange polymers and devices including the stable hydroxide ion-exchagne polymers. The polymers include ionenes, which are polymers that contain ionic amines in the backbone. The polymers are alcohol-soluble and water-insoluble. The polymers have a water uptake and an ionic conductivity that are correlated to a degree of N-substitution. Methods of forming the polymers and membranes including the polymers are also provided. The polymers are suitable, for example, for use as ionomers in catalyst layers for fuel cells and electrolyzers.

### Definitions

At various places in the present specification, substituents of compounds of the disclosure are disclosed in groups or in ranges. It is specifically intended that the disclosure include each and every individual subcombination of the members of such groups and ranges. For example, the term “C₁₋₆ alkyl” is specifically intended to individually disclose methyl, ethyl, C₃ alkyl, C₄ alkyl, C₅ alkyl, and C₆ alkyl.

It is further intended that the compounds of the disclosure are stable. As used herein “stable” refers to a compound that is sufficiently robust to survive isolation to a useful degree of purity from a reaction mixture.

It is further appreciated that certain features of the disclosure, which are, for clarity, described in the context of separate embodiments, can also be provided in combination in a single embodiment. Conversely, various features of the disclosure which are, for brevity, described in the context of a single embodiment, can also be provided separately or in any suitable subcombination.

“Optionally substituted” groups can refer to, for example, functional groups that may be substituted or unsubstituted by additional functional groups. For example, when a group is unsubstituted, it can be referred to as the group name, for example alkyl or aryl. When a group is substituted with additional functional groups, it may more generically be referred to as substituted alkyl or substituted aryl.

As used herein, the term “substituted” or “substitution” refers to the replacing of a hydrogen atom with a substituent other than H. For example, an “N-substituted piperidin-4-yl” refers to replacement of the H atom from the NH of the piperidinyl with a non-hydrogen substituent such as, for example, alkyl.

As used herein, the term “alkyl” refers to a straight or branched hydrocarbon groups having the indicated number of carbon atoms. Representative alkyl groups include methyl (—CH₃), ethyl, propyl (e.g., n-propyl, isopropyl), butyl (e.g., n-butyl, sec-butyl, and tert-butyl), pentyl (e.g., n-pentyl, tert-pentyl, neopentyl, isopentyl, pentan-2-yl, pentan-3-yl), and hexyl (e.g., n-pentyl and isomers) groups.

As used herein, the term “alkylene” refers to a linking alkyl group.

As used herein, the term “perfluoroalkyl” refers to straight or branched fluorocarbon chains. Representative alkyl groups include trifluoromethyl, pentafluoroethyl, etc.

As used herein, the term “perfluoroalkylene” refers to a linking perfluoroalkyl group.

As used herein, the term “heteroalkyl” refers to a straight or branched chain alkyl groups having the indicated number of carbon atoms and where one or more of the carbon atoms is replaced with a heteroatom selected from O, N, or S.

As used herein, the term “heteroalkylene” refers to a linking heteroalkyl group.

As used herein, the term “alkoxy” refers to an alkyl or cycloalkyl group as described herein bonded to an oxygen atom. Representative alkoxy groups include methoxy, ethoxy, propoxy, and isopropoxy groups.

As used herein, the term “perfluoroalkoxy” refers to a perfluoroalkyl or cyclic perfluoroalkyl group as described herein bonded to an oxygen atom. Representative perfluoroalkoxy groups include trifluoromethoxy, pentafluoroethoxy, etc.

As used herein, the term “aryl” refers to an aromatic hydrocarbon group having 6 to 10 carbon atoms. Representative aryl groups include phenyl groups. In some embodiments, the term “aryl” includes monocyclic or polycyclic (e.g., having 2, 3, or 4 fused rings) aromatic hydrocarbons such as, for example, phenyl, naphthyl, anthracenyl, phenanthrenyl, indanyl, and indenyl.

As used herein, the term “arylene” refers to a linking aryl group.

As used herein, the term “aralkyl” refers to an alkyl or cycloalkyl group as defined herein with an aryl group as defined herein substituted for one of the alkyl hydrogen atoms. A representative aralkyl group is a benzyl group.

As used herein, the term “aralkylene” refers to a linking aralkyl group.

As used herein, the term “heteroaryl” refers to a 5- to 10-membered aromatic monocyclic or bicyclic ring containing 1-4 heteroatoms selected from O, S, and N. Representative 5- or 6-membered aromatic monocyclic ring groups include pyridine, pyrimidine, pyridazine, furan, thiophene, thiazole, oxazole, and isooxazole. Representative 9- or 10-membered aromatic bicyclic ring groups include benzofuran, benzothiophene, indole, pyranopyrrole, benzopyran, quionoline, benzocyclohexyl, and naphthyridine.

As used herein, the term “heteroarylene” refers to a linking heteroaryl group.

As used herein, the term “halogen” or “halo” refers to fluoro, chloro, bromo, and iodo groups.

As used herein, the term “bulky group” refers to a group providing steric bulk by having a size at least as large as a methyl group.

As used herein, the term “copolymer” refers to a polymer that is the result of polymerization of two or more different monomers. The number and the nature of each constitutional unit can be separately controlled in a copolymer. The constitutional units can be disposed in a purely random, an alternating random, a regular alternating, a regular block, or a random block configuration unless expressly stated to be otherwise. A purely random configuration can, for example, be: x-x-y-z-x-y-y-z-y-z-z-z . . . or y-z-x-y-z-y-z-x-x . . . . An alternating random configuration can be: x-y-x-z-y-x-y-z-y-x-z . . . , and a regular alternating configuration can be: x-y-z-x-y-z-x-y-z . . . . A regular block configuration (i.e., a block copolymer) has the following general configuration: . . . x-x-x-y-y-y-z-z-z-x-x-x . . . , while a random block configuration has the general configuration: . . . x-x-x-z-z-x-x-y-y-y-y-z-z-z-x-x-z-z-z- . . . .

As used herein, the term “random copolymer” is a copolymer having an uncontrolled mixture of two or more constitutional units. The distribution of the constitutional units throughout a polymer backbone (or main chain) can be a statistical distribution, or approach a statistical distribution, of the constitutional units. In some embodiments, the distribution of one or more of the constitutional units is favored.

As used herein, the term “constitutional unit” of a polymer refers to an atom or group of atoms in a polymer, comprising a part of the chain together with its pendant atoms or groups of atoms, if any. The constitutional unit can refer to a repeat unit. The constitutional unit can also refer to an end group on a polymer chain. For example, the constitutional unit of polyethylene glycol can be —CH₂CH₂O— corresponding to a repeat unit, or —CH₂CH₂OH corresponding to an end group.

As used herein, the term “repeat unit” corresponds to the smallest constitutional unit, the repetition of which constitutes a regular macromolecule (or oligomer molecule or block).

As used herein, the term “end group” refers to a constitutional unit with only one attachment to a polymer chain, located at the end of a polymer. For example, the end group can be derived from a monomer unit at the end of the polymer, once the monomer unit has been polymerized. As another example, the end group can be a part of a chain transfer agent or initiating agent that was used to synthesize the polymer.

As used herein, the term “terminus” of a polymer refers to a constitutional unit of the polymer that is positioned at the end of a polymer backbone.

As used herein, the term “cationic” refers to a moiety that is positively charged, or ionizable to a positively charged moiety under physiological conditions. Examples of cationic moieties include, for example, amino, ammonium, pyridinium, imino, sulfonium, quaternary phosphonium groups, etc.

As used herein, the term “anionic” refers to a functional group that is negatively charged, or ionizable to a negatively charged moiety under physiological conditions. Examples of anionic groups include carboxylate, sulfate, sulfonate, phosphate, etc.

As used herein, when a benzimidazolium has a ring-forming nitrogen atom that is positively charged, it is understood that that the double bond may be located in one of two positions and the positive charge is consequently localized on one of the ring-forming nitrogen atoms:

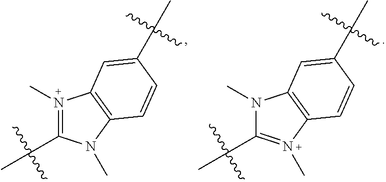

The positive charge can also be illustrated as delocalized between the two ring-forming nitrogen atoms in the benzimidazolium:

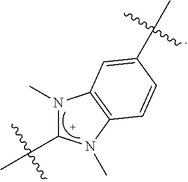 [SMILES: *c1ccc2c(c1)n(C)[c+](*)n2C]

As used herein, “degree of methylation” (dm) refers to the percentage of N-methylation of, for example, a polymer of Formula (I), below. Thus, if a=100 mol %, the degree of methylation is 50%; if c=100 mol %, the degree of methylation is 100%.

As used herein, the term “consisting essentially of” or “consists essentially of” refers to a composition including the components of which it consists essentially as well as other components, provided that the other components do not materially affect the essential characteristics of the composition. Typically, a composition consisting essentially of certain components will comprise greater than or equal to 95 wt % of those components or greater than or equal to 99 wt % of those components.

Unless otherwise defined, all technical and scientific terms used herein have the same meaning as commonly understood by one of ordinary skill in the art. Although methods and materials similar or equivalent to those described herein can be used in the practice or testing of the present disclosure, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

### Membrane

This disclosure provides, inter alia, a catalyst-coated membrane, including:

(a) a film including a random copolymer of Formula (I)

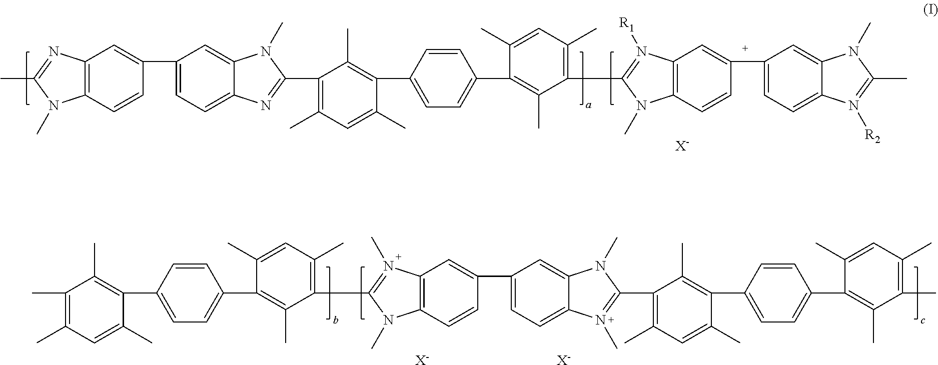

wherein

X⁻ is an anion selected from iodide, bromide, chloride, fluoride, hydroxide, carbonate, bicarbonate, sulfate, tetrakis(3,5-bis(trifluoromethyl)phenyl)borate, bis(trifluoromethane)sulfonamide, and any combination thereof, wherein X⁻ counterbalances a positive charge in the polymer;

R₁ and R₂ are each independently selected from absent and methyl,

provided that R₁ and R₂ are not both absent, or both methyl;

provided that when one of R₁ or R₂ is methyl, the other is absent; and

provided that when R₁ or R₂ is methyl, the nitrogen to which the methyl is connected to is positively charged,

a, b, and c are mole percentages, wherein

a is from 0 mole % to 45 mole % (e.g., from 0 mole % to 35 mole %, from 0 mole % to 25 mole %, from 0 mole % to 10 mole %),

b+c is 55 mole % to 100 mole % (e.g., from 65 mole % to 100 mole %, from 75 mole % to 100 mole %, from 90 mole % to 100 mole %),

b and c are each more than 0%, and

a+b+c=100%, and

(b) a catalyst coating on the film, the catalyst coating comprising from 5% to 35% by weight of the polymer of Formula (I) and from 65% to 95% by weight of a metal or non-metal catalyst.

In some embodiments, the present disclosure features a catalyst-coated membrane, consisting essentially of, or consisting of:

(a) a film including a random copolymer of Formula (I)

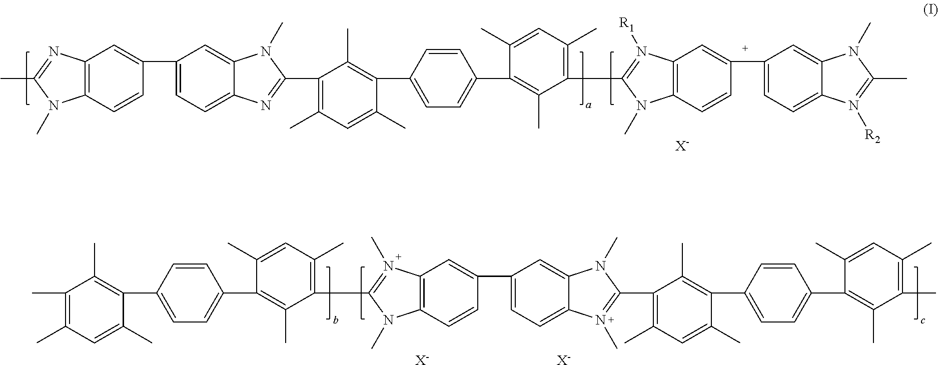

wherein

X⁻ is an anion selected from iodide, bromide, chloride, fluoride, hydroxide, carbonate, bicarbonate, sulfate, tetrakis(3,5-bis(trifluoromethyl)phenyl)borate, bis(trifluoromethane)sulfonamide, and any combination thereof, wherein X⁻ counterbalances a positive charge in the polymer;

R₁ and R₂ are each independently selected from absent and methyl,

provided that R₁ and R₂ are not both absent, or both methyl;

provided that when one of R₁ or R₂ is methyl, the other is absent; and

provided that when R₁ or R₂ is methyl, the nitrogen to which the methyl is connected to is positively charged,

a, b, and c are mole percentages, wherein

a is from 0 mole % to 45 mole % (e.g., from 0 mole % to 35 mole %, from 0 mole % to 25 mole %, from 0 mole % to 10 mole %),

b+c is 55 mole % to 100 mole % (e.g., from 65 mole % to 100 mole %, from 75 mole % to 100 mole %, from 90 mole % to 100 mole %),

b and c are each more than 0%, and

a+b+c=100%, and

(b) a catalyst coating on the film, the catalyst coating comprising from 5% to 35% by weight of the polymer of Formula (I) and from 65% to 95% by weight of a metal or non-metal catalyst.

Further examples of polymers that can be incorporated into catalyst coated membranes are described in PCT/CA2015/000248, filed Apr. 14, 2015, herein incorporated by reference in its entirety.

In some embodiments, the polymer of Formula (I) includes from 80% to 95% degree of methylation (e.g., from 85% to 95% degree of methylation, from 85% to 90% degree of methylation, from 85% to 92% degree of methylation, from 87% to 92% degree of methylation).

In some embodiments, the catalyst coating includes from 10% to 30% (e.g., from 10% to 25%, from 10% to 20%, from 10% to 15%, from 15% to 30%, from 20% to 30%, or from 25% to 30%) by weight of the polymer of Formula (I).

In some embodiments, the catalyst coating includes from 10% to 65% (e.g., from 11% to 65%, from 15% to 65%, from 20% to 65%, from 30% to 65%, from 40% to 65%, from 50 to 65%, from 10% to 65%, from 10% to 50%, from 10% to 40%, from 10% to 30%, from 10% to 20%, from 20% to 30%, from 20% to 40%, from 20% to 50%, from 30% to 40% or from 30% to 50) by weight of the metal or non-metal catalyst. The metal catalyst can be, for example, carbon-supported Pt (platinum), alkaline-stable metal-supported Pt, non-supported Pt, carbon-supported Pt alloy, alkaline-stable metal-supported Pt alloy, non-supported Pt alloy, and/or any combination thereof. In some embodiments, the alkaline-stable metal-supported Pt is Sn (tin)-supported Pt, Ti (titanium)-supported Pt, Ni (nickel)-supported Pt, and/or any combination thereof. In some embodiments, the alkaline-stable metal-supported Pt alloy is Sn-supported Pt alloy, Ti-supported Pt alloy, Ni-supported Pt alloy, and/or any combination thereof. In some embodiments, the carbon-supported Pt includes from 20% by weight to 50% by weight (e.g., from 20% to 40% by weight, from 30% to 50% by weight, or from 30% to 40% by weight) of Pt. In some embodiments, the metal catalyst is selected from supported Pt black and non-supported Pt black. In certain embodiments, the Pt alloy can be a Pt—Ru (ruthenium) alloy, a Pt—Ir (iridium) alloy, and/or a Pt—Pd (palladium) alloy. In some embodiments, the metal catalyst is selected from Ag, Ni, alloys thereof, and any combination thereof.

The non-metal catalyst can be a doped graphene (e.g., a doped reduced graphene oxide) and/or a doped carbon nanotube. In some embodiments, the non-metal catalyst is a doped graphene. The doped graphene can be, for example, a graphene that is doped with S (sulfur), N (nitrogen), F (fluorine), a metal, and/or a combination thereof. In certain embodiments, the doped graphene can be, for example, a graphene that is doped with S, N, F, and/or a combination thereof. In certain embodiments, the doped graphene is a F, N, and S doped reduced graphene oxide. In some embodiments, the non-metal catalyst is a doped carbon nanotube. The doped carbon nanotube can be, for example, a carbon nanotube that is doped with S (sulfur), N (nitrogen), F (fluorine), a metal, and/or a combination thereof. In certain embodiments, the doped carbon nanotube can be, for example, a carbon nanotube that is doped with S, N, F, and/or a combination thereof. In certain embodiments, the doped carbon nanotube is a F, N, and S doped carbon nanotube.

In some embodiments, the membrane undergoes less than 5% (e.g., less than 3%, less than 1%) ring opening degradation, as determined by proton nuclear magnetic resonance (NMR) spectroscopic analysis, when subjected to an aqueous solution comprising from 1 M to 6 M hydroxide at room temperature for at least 168 hours.

In some embodiments, a polymer of Formula (I) is hexamethyl-p-terphenyl poly(benzimidazolium), HMT-PMBI, which can be prepared by methylation of poly[2,2′-(2,2″,4,4″,6,6″-hexamethyl-p-terphenyl-3,3″-diyl)-5,5′-bibenzimidazole] (HMT-PBI). The polymer can be used as both the polymer electrolyte membrane and ionomer in an alkaline anion-exchange membrane fuel cell and alkaline polymer electrolyzer. A fuel cell including a catalyst-coated membrane including the polymer of Formula (I), when operated between 60 and 90° C. and subjected to operational shutdown, restarts, and CO₂-containing air, can have remarkable in situ stability for >4 days, over which its performance improved over time. When similarly operated in a water electrolyzer with circulating 1 M KOH electrolyte at 60° C., the membrane performance can be unchanged after 8 days of operation. In a fully-hydrated chloride form, polymer membranes of the present disclosure can be mechanically strong, and have a tensile strength and Young's modulus that is significantly higher than Nafion 212, for example. The hydroxide anion form of a membrane including a polymer of Formula (I) can have remarkable ex situ chemical and mechanical stability and be relatively unchanged after a 7 days exposure to 1 M NaOH at 80° C. or 6 M NaOH at 25° C. The membrane can exhibit little to no chemical degradation when exposed to 2 M NaOH at 80° C. for 7 days. Furthermore, polymers of the present disclosure can be soluble in low boiling solvents such as methanol, and allow for processability by a variety of casting or coating methods and incorporation of the polymers into catalyst inks.

### Fuel Cells

The present disclosure features a fuel cell that includes a catalyst-coated membrane described above. The catalyst-coated membrane can have two sides, where one side of the catalyst-coated membrane is a cathode, and the other side of the catalyst-coated membrane is an anode. The catalyst-coated membrane can be a pre-conditioned catalyst-coated membrane, such as a pre-conditioned catalyst-coated membrane that is obtained by immersing the catalyst-coated membrane in a 1 M to 2 M aqueous hydroxide solution for 1 to 24 hours (e.g., 1 to 12 hours, 12 to 24 hours, or 6 to18 hours).

In some embodiments, the fuel cell is made by (a) pre-conditioning a catalyst-coated membrane above by contacting the catalyst-coated membrane with an aqueous hydroxide solution for at least 1 hour to provide a pre-conditioned catalyst-coated membrane; and (b) incorporating the pre-conditioned catalyst-coated membrane into a fuel cell.

In some embodiments, the fuel cell is made by (a) incorporating a catalyst-coated membrane above into a fuel cell; and (b) pre-conditioning the fuel cell by contacting the catalyst-coated membrane with an aqueous hydroxide solution for at least 1 hour to provide a pre-conditioned catalyst-coated membrane. In some embodiments, after contacting the catalyst-coated membrane with an aqueous hydroxide solution, the catalyst-coated membrane can be contacted with water for at least 1 day.

In some embodiments, in the fuel cell, the catalyst-coated membrane is a random copolymer of Formula (I), wherein X⁻ is an anion such as iodide, bromide, chloride, fluoride, and/or any combination thereof; after immersing the catalyst-coated membrane in a 1 M to 2 M aqueous hydroxide solution for 1 to 24 hours, X⁻ is exchanged for an anion such as hydroxide, carbonate, bicarbonate, and/or any combination thereof.

The catalyst-coated membrane can include a cathode catalyst loading of 0.1 mg to 5 mg (e.g., 0.1 mg to 4 mg, 0.1 mg to 3 mg, 0.1 mg to 2 mg, 0.1 mg to 1 mg, 1 mg to 5 mg, 1.0 mg to 4 mg, 1.0 mg to 3 mg, 1.0 to 2 mg, 2 mg to 5 mg, 2 mg to 4 mg, 2 mg to 3 mg, 3 mg to 5 mg, or 3 mg to 4 mg) metal or non-metal catalyst per cm² and an anode catalyst loading of 0.1 mg to 5.0 mg (e.g., 0.1 mg to 4 mg, 0.1 mg to 3 mg, 0.1 mg to 2 mg, 0.1 mg to 1 mg, 1 mg to 5 mg, 1.0 mg to 4 mg, 1.0 mg to 3 mg, 1.0 to 2 mg, 2 mg to 5 mg, 2 mg to 4 mg, 2 mg to 3 mg, 3 mg to 5 mg, or 3 mg to 4 mg) metal or non-metal catalyst per cm².

In certain embodiments, the catalyst-coated membrane includes a cathode catalyst loading of 0.1 mg to 1.0 mg (e.g., 0.1 mg to 0.8 mg, 0.1 mg to 0.6 mg, 0.1 mg to 0.5 mg, 0.1 mg to 0.4 mg, 0.1 to 0.3 mg, 0.1 to 0.2 mg, 0.3 mg to 1.0 mg, 0.5 mg to 1.0 mg, 0.7 mg to 1.0 mg, 0.3 mg to 0.8 mg, 0.3 mg to 0.5 mg) of a metal or non-metal catalyst per cm² and an anode catalyst loading of 0.1 mg to 1.0 mg (e.g., 0.1 mg to 0.8 mg, 0.1 mg to 0.6 mg, 0.1 mg to 0.5 mg, 0.1 mg to 0.4 mg, 0.1 mg to 0.3 mg, 0.1 to 0.2 mg, 0.3 mg to 1.0 mg, 0.5 mg to 1.0 mg, 0.7 mg to 1.0 mg, 0.3 mg to 0.8 mg, 0.3 mg to 0.5 mg) of a metal or non-metal catalyst per cm². In some embodiments, the catalyst-coated membrane includes a cathode catalyst loading of 0.1 mg to 0.5 mg of a metal or non-metal catalyst per cm² and an anode catalyst loading of 0.1 mg to 0.5 mg of a metal or non-metal catalyst per cm².

In some embodiments, the fuel cell is capable of operating at a power density of 20 mW/cm² or more (e.g., 25 mW/cm² or more, or 30 mW/cm² or more), at 60° C. to 90° C., for more than 4 days. In some embodiments, the power densities of the fuel cell is 1 W/cm² or greater (e.g., for an optimized fuel cell). In some embodiments, when the fuel cell is shut down after a period of operation and restarted, the fuel cell is capable operating with a decrease of 5% or less (e.g., 3% or less, 1% or less) in power density within 6 hours of restarting.

The fuel cell can be operated in an atmosphere comprising carbon dioxide, oxygen, and water at the cathode. In some embodiments, the fuel cell is operated in an oxygen and water atmosphere at the cathode. In certain embodiments, the fuel cell is operated in a carbon dioxide-free atmosphere at the cathode.

The fuel cell can be operated in a hydrogen atmosphere at the anode. In some embodiments, the fuel cell is operated in an atmosphere that includes methanol, ethanol, hydrazine, formaldehyde, ethylene glycol, or any combination thereof at the anode.

Methods of Use

The present disclosure also features, inter alia, a method of operating a fuel cell described above, including (a) conditioning the fuel cell by supplying hydrogen to the anode, and oxygen and water to the cathode, and operating the fuel cell to generate electrical power and water at a potential of 1.1 V to 0.1 V (e.g., 1.1 V to 0.3 V, 1.1 V to 0.5 V, 1.1 V to 0.8 V, 0.8 V to 0.3 V, 0.8 V to 0.5 V, 0.8 V to 0.6 V, 0.6 to 0.2 V, or 0.6 V to 0.4 V) and at a temperature of 20° C. to 90° C. (e.g., 40° C. to 90° C., 40° C. to 70° C., 60° C. to 90° C., or 60° C. to 90° C.), until the fuel cell reaches at least 90% of peak performance (e.g., at least 95% of peak performance, at least 99% of peak performance, or 99% of peak performance); and (b) continuing supplying hydrogen to the anode and oxygen and water to the cathode, and operating the fuel cell at a potential of 1.1 V to 0.1 V (e.g., 1.1 V to 0.3 V, 1.1 V to 0.5 V, 1.1 V to 0.8 V, 0.8 V to 0.3 V, 0.8 V to 0.5 V, 0.8 V to 0.6 V, 0.6 to 0.2 V, or 0.6 V to 0.4 V) and a temperature of 20° C. to 90° C. (e.g., 40° C. to 90° C., 40° C. to 70° C., 60° C. to 90° C., or 60° C. to 90° C.).

In some embodiments, the catalyst-coated membrane is treated with aqueous hydroxide prior to conditioning the fuel cell. In some embodiments, the catalyst-coated membrane is exposed to carbon dioxide prior to conditioning the fuel cell.

During operation of the fuel cell, the maximum power density can increase (e.g., increase by 5%, increase by 10%, increase by 15%, increase by 20%, increase by 30%, or increase by 50% compared to initial maximum power density).

In addition to steps (a) and (b) above, the method can further include:

(c) stopping the supply of hydrogen to the anode and/or oxygen and water to the cathode (e.g., stopping the supply of hydrogen to the anode and oxygen and water to the cathode) to stop operation of the fuel cell;

(d) cooling the fuel cell to below 40° C. (e.g., or below 30° C.); and

(e) reconditioning the fuel cell by supplying hydrogen to the anode, and oxygen and water to the cathode, and operating the fuel cell to generate electrical power and water at a potential of 1.1 V to 0.1V (e.g., 1.1 V to 0.3 V, 1.1 V to 0.5 V, 1.1 V to 0.8 V, 0.8 V to 0.3 V, 0.8 V to 0.5 V, 0.8 V to 0.6 V, 0.6 to 0.2 V, or 0.6 V to 0.4 V) and at a temperature of 20° C. to 90° C. (e.g., 40° C. to 90° C., 40° C. to 70° C., 60° C. to 90° C., or 60° C. to 90° C.).

Supplying oxygen to the cathode can include supplying a mixture of oxygen, carbon dioxide, and water to the cathode.

In some embodiments, the fuel cell has a performance that decreases by less than 5% (e.g., 3% or less, 1% or less) in power density and/or increases by less than 5% (e.g., 3% or less, 1% or less) in total resistance within 6 hours of reconditioning the fuel cell, wherein the performance is determined by a total resistance in an Ohmic region measured using a current-interrupt method, a high-frequency resistance method, or both, and/or wherein the performance is determined by a peak power density in polarization data measured by increasing current from open circuit at set intervals of 20-200 mA/cm² at a time of 1 minute or more per point.

In some embodiments, the fuel cell is operated at a temperature of 20° C. to 90° C., and the fuel cell has a power density of greater than 25 mW/cm² (e.g., greater than 30 mW/cm² or more, or greater than 35 mW/cm²).

### Water Electrolyzer

In present disclosure also features, inter alia, a water electrolyzer, including a catalyst-coated membrane above, wherein the catalyst-coated membrane has two sides, and one side of the catalyst-coated membrane is a cathode, and the other side of the catalyst-coated membrane is an anode. The catalyst-coated membrane can include a cathode catalyst loading of 0.1 mg to 5 mg (e.g., 0.1 mg to 4 mg, 0.1 mg to 3 mg, 0.1 mg to 2 mg, 0.1 mg to 1 mg, 1 mg to 5 mg, 1.0 mg to 4 mg, 1.0 mg to 3 mg, 1.0 to 2 mg, 2 mg to 5 mg, 2 mg to 4 mg, 2 mg to 3 mg, 3 mg to 5 mg, or 3 mg to 4 mg) metal or non-metal catalyst per cm² and an anode catalyst loading of 0.1 mg to 5.0 mg (e.g., 0.1 mg to 4 mg, 0.1 mg to 3 mg, 0.1 mg to 2 mg, 0.1 mg to 1 mg, 1 mg to 5 mg, 1.0 mg to 4 mg, 1.0 mg to 3 mg, 1.0 to 2 mg, 2 mg to 5 mg, 2 mg to 4 mg, 2 mg to 3 mg, 3 mg to 5 mg, or 3 mg to 4 mg) metal or non-metal catalyst per cm².

The electrolyzer can be made by (a) incorporating a catalyst-coated membrane described above into the electrolyzer; and (b) pre-conditioning the electrolyzer by contacting the catalyst-coated membrane with an aqueous hydroxide solution for at least 1 hour to provide a pre-conditioned catalyst-coated membrane.

In some embodiments, the electrolyzer is made by (a) pre-conditioning a catalyst-coated membrane described above by contacting the catalyst-coated membrane with an aqueous hydroxide solution for at least 1 hour to provide a pre-conditioned catalyst-coated membrane; and (b) incorporating the pre-conditioned catalyst-coated membrane into an electrolyzer.

In some embodiments, after contacting the catalyst-coated membrane with an aqueous hydroxide solution, the catalyst-coated membrane is contacted with water for at least 7 days (e.g., at least 10 days, or at least 14 days).

In some embodiments, the water electrolyzer is capable of being operated at 25 mA/cm² or more for 144 hours or more (e.g., 175 hours or more, 200 hours or more), at an overall applied potential of 1.6 V or more (e.g., 1.8 V or more). In some embodiments, the water electrolyzer is capable of being operated at a pressure at the cathode of up to 30 bar (e.g., up to 25 bar, or up to 20 bar) and a pressure at the anode of up to 30 bar (e.g., up to 25 bar, or up to 20 bar), the pressure at the cathode and the pressure at the anode can be the same or different.

In some embodiments, when the water electrolyzer is shut down after a period of operation and restarted, the water electrolyzer is capable of operating with less than a 5% increase (e.g., less than 3% increase, or less than 1% increase) in potential at a current density achieved within 6 hours of restarting the water electrolyzer.

Methods of Use

The water electrolyzer of the present disclosure can be operated by (a) providing water or an aqueous hydroxide electrolyte solution at 20° C. to 80° C. (e.g., 40° C. to 90° C., 40° C. to 70° C., 60° C. to 90° C., or 60 OC to 90° C.) to the anode, the cathode, or both the anode and the cathode of the water electrolyzer; and (b) operating the water electrolyzer to generate hydrogen, oxygen, and water. In some embodiments, the water or the aqueous hydroxide electrolyte solution is provided alternately to the cathode and the anode.

In some embodiments, prior to step (a), the electrolyzer is further pre-conditioned by contacting the catalyst-coated membrane with an aqueous hydroxide solution for at least 1 hour.

An example of a membrane of the present disclosure, including hexamethyl-p-terphenyl poly(benzimidazolium), is provided in Example 1 below, and illustrates a hydroxide-conducting polymer that can be used for energy conversion devices. Example 2, below, illustrates the use of a F-, N-, and S-doped metal free reduced graphene oxide catalyst that is used in a membrane including hexamethyl-p-terphenyl poly(benzimidazolium) for energy conversion devices.

### EXAMPLES

### Example 1. Hexamethyl-p-terphenyl poly(benzimidazolium)

A hydroxide-conducting polymer, hexamethyl-p-terphenyl poly(benzimidazolium), HMT-PMBI, was prepared by methylation of poly[2,2′-(2,2″,4,4″,6,6″-hexamethyl-p-terphenyl-3,3″-diyl)-5,5′-bibenzimidazole] (HMT-PBI), and was utilized as both the polymer electrolyte membrane and ionomer in an alkaline anion-exchange membrane fuel cell and alkaline polymer electrolyzer. HMT-PBI was prepared as described, for example, in A. G. Wright and S. Holdcroft, ACS Macro Lett., 2014, 3, 444-447, incorporated herein by reference in its entirety. A fuel cell operating between 60 and 90° C. and subjected to operational shutdown, restarts, and CO₂-containing air, demonstrated remarkable in situ stability for >4 days, over which its performance improved over time. An HMT-PMBI-based fuel cell was operated at current densities >1000 mA cm⁻² and power densities of 370 mW cm⁻² at 60° C. When similarly operated in a water electrolyzer with circulating 1 M KOH electrolyte at 60° C., its performance was unchanged after 8 days of operation. Methodology for up-scaled synthesis of HMT-PMBI is also described below, wherein >1/2 kg was synthesized in six steps with a yield of 42%. Each step was optimized to achieve high batch-to-batch reproducibility. Water uptake, dimensional swelling, and ionic conductivity of HMT-PMBI membranes exchanged with various anions are described. In the fully-hydrated chloride form, HMT-PMBI membranes were mechanically strong, and possessed a tensile strength and Young's modulus of 33 MPa and 225 MPa, respectively, which is significantly higher than Nafion 212, for example. The hydroxide anion form shows remarkable ex situ chemical and mechanical stability and appeared unchanged after a 7 days exposure to 1 M NaOH at 80° C. or 6 M NaOH at 25° C. Only 6% chemical degradation was observed when exposed to 2 M NaOH at 80° C. for 7 days. The ease of synthesis, synthetic reproducibility, scale up, and exceptional in situ and ex situ properties of HMT-PMBI presented a useful polymer for energy conversion devices requiring an anion-exchange material.

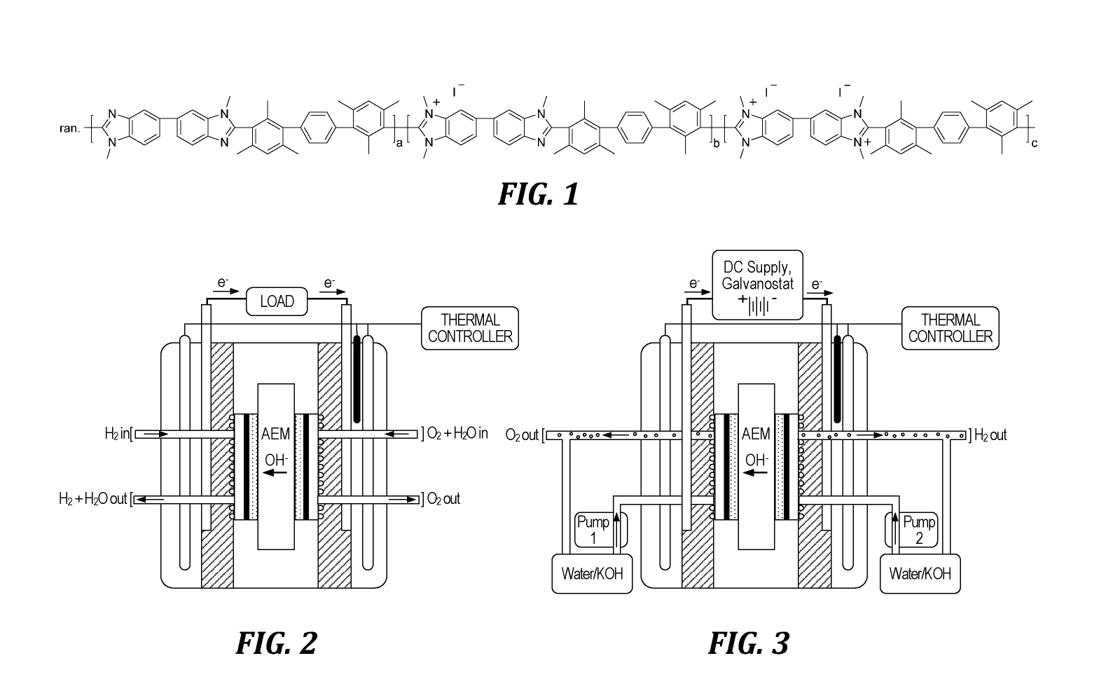

A polymeric material that has been demonstrated to exhibit exceptional chemical stability is based on poly[2,2′-(2,2″,4,4″,6,6″-hexamethyl-p-terphenyl-3,3″-diyl)-5,5′-bibenzimidazole] (HMT-PBI), which can be controllably methylated to form HMT-PMBI, as shown in FIG. 1.

The HMT-PMBI ionene possesses steric hindrance around the C₂-position as well as increased spacing between benzimidazolium groups, thus having enhanced stability against hydroxide ion attack. Referring to FIG. 1, HMT-PMBI is composed of three distinct units: repeat unit a represents a monomer unit possessing 50% degree of methylation (dm), unit b represents 75% dm, and unit c represents a unit possessing 100% dm. As the degree of methylation is increased, the ion exchange capacity (IEC), water uptake, and conductivity of the membrane are increased. For a fully methylated derivative (100% dm), the polymer is soluble in water in its hydroxide ion form. However, a polymer methylated to <92% dm and converted to its hydroxide ion form is insoluble in water and shows no observable degradation when dissolved in a 2 M KOH methanol solution at 60° C. for 8 days. Additionally, the solubility of these cationic polymers in low boiling solvents such as methanol allows for processability by a variety of casting or coating methods and incorporation of the polymers into catalyst inks.

In this example, the up-scaled synthesis of HMT-PMBI is presented, showing the versatility and reproducibility of its modified synthesis. Additionally, large scale synthesis allowed for extensive characterization of ionene-based membranes and elucidation of properties. Every synthetic step was addressed for high yield and high purity, particularly the post-functionalization steps, where the yield is improved by >20% compared to a previous report. The 89% dm HMT-PMBI polymer, possessing a theoretical OH⁻ IEC of 2.5 mmol g⁻¹, was chosen for extensive study due to the balance of high conductivity and low water uptake. The tensile strength and elongation at break were compared to commercial proton-exchange ionomer materials. Water uptake, dimensional swelling, and conductivity of various anions were determined and the upper limit of stability was found using extensive degradation tests. By utilizing the material as both the membrane and ionomer in an alkaline AEMFC and water electrolyzer for more than 4 days, the stable cationic polymer was demonstrated to operate between 60 and 90° C. incorporating shutdowns, restarts, and exposure to CO₂ during the operational cycle.

Synthesis

Materials and Chemicals.

Chemicals were purchased from Sigma Aldrich unless otherwise noted. Acetic acid (glacial) and potassium iodide (99.0%) were purchased from Caledon Laboratories Ltd. Mesitoic acid (98%) and 1,4-phenylenediboronic acid (97%) were purchased from Combi-Blocks, Inc. Ethanol (anhydrous grade) was purchased from Commercial Alcohols. Potassium hydroxide (ACS grade, pellets) was purchased from Macron Fine Chemicals. Dimethylsulfoxide (spectrograde), potassium carbonate (99.0%), potassium chloride (ACS grade), sodium bicarbonate (ACS grade), and hexanes (ACS grade) were purchased from ACP Chemicals Inc. Methylene chloride (ACS grade, stabilized), silica (230-400 mesh, grade 60), sodium dithionite, acetone (ACS grade), methanol (ACS grade), and sodium chloride (ACS grade) were purchased from Fisher Scientific. Chloroform (ACS grade) and sodium hydroxide (ACS grade) were purchased from BDH. Activated charcoal (G-60) and hydrochloric acid (ACS grade) were purchased from Anachemia. Tetrakis(triphenylphosphine)palladium (99%) was purchased from Strem Chemicals. Dimethylsulfoxide-d₆ (99.9%-D), chloroform-D (99.8%-D), and methylene chloride-d₂ (99.9%-D) were purchased from Cambridge Isotope Laboratories, Inc. Nuclear magnetic resonance (NMR) spectra were obtained on a 400 or 500 MHz Bruker AVANCE III running IconNMR under Top Spin 2.1. The residual ¹H NMR (nuclear magnetic resonance) solvent peaks for DMSO-d₆, CDCl₃, and CD₂Cl₂ were set to 2.50 ppm, 7.26 ppm, and 5.36 ppm, respectively. The residual ¹³C NMR solvent peaks for DMSO-d₆ and CDCl₃ were set to 39.52 ppm and 77.16 ppm, respectively. All NMR solutions had a solution concentration between 20 and 80 g/L. The conductivity measurements under controlled humidity and temperature were collected in an Espec SH-241 chamber. The 5 L reactor used was a cylindrical jacketed flask (all glass), allowing the temperature to be controlled by a circulation of oil around the reactant mixture, which was generally a different temperature than the measured internal (reactant mixture) temperature. Eaton's reagent was prepared prior to polymerization by stirring P₂O₅ (308.24 g) in methanesulfonic acid (2.5 L) at 120° C. under argon until dissolved, where it was then stored in sealed glass bottles until needed. Deionized water (DI water) was purified to 18.2 MΩ cm using a Millipore Gradient Milli-Q® water purification system. MBIM-I⁻ (2-mesityl-1,3-dimethyl-1H-benzimidazolium iodide) was synthesized according to literature.

### Synthesis of 3-bromomesitoic acid (BMA)

To a 5 L reactor was added glacial acetic acid (1.0 L) followed by mesitoic acid (225.1 g, 1.37 mol). The circulator temperature was set to 28.0° C. and mechanical stirred at 140 rpm. More glacial acetic acid was added (1.0 L) and stirred for approximately 30 min until the mesitoic acid fully dissolved. Bromine (100 mL, 1.95 mol) was added slowly over 5 min followed by glacial acetic acid (500 mL) to rinse down the sides. After 10 min, the internal temperature was observed to be 10° C. The red mixture was stirred for 50 min, whereupon the internal temperature returned to approximately 25° C. The mixture was then transferred by liquid transfer pump and PTFE tubing into 9 L of stirring distilled water (3×4 L beakers). The foamy precipitate was collected by vacuum filtration (requiring multiple funnels to collect all solid), compressed with a wide spatula to better dry the solid, and washed with water until white (˜2 L total). The cakes were transferred to a 4 L beaker. The solid was recrystallized from approximately 2750 mL of 60% ethanol by boiling and then cooling to room temperature. The fluffy needles were collected by vacuum filtration, washed with room temperature 33% ethanol, and thoroughly dried at 80° C. under vacuum. This resulted in approximately 320 g of white needles. Two of these batches were combined and recrystallized a second time in 2700 mL of 55% ethanol, collected, washed with 33% ethanol, and dried under vacuum at 80° C. to yield 577.5 g of BMA as white fluffy needles (86.6%). ¹H NMR (500 MHz, DMSO-d₆, ppm) δ: 13.33 (s, 1H), 7.09 (s, 1H), 2.33 (s, 3H), 2.32 (s, 3H), 2.19 (s, 3H). ¹³C NMR (125 MHz, DMSO-d₆, ppm) δ: 170.02, 138.09, 135.11, 132.86, 132.19, 129.95, 124.45, 23.44, 20.88, 18.71. This procedure was repeated once more. The resulting data is shown in Table 1.

TABLE 1
Yield of BMA for each reaction performed.

| Reaction # | Yield (g) | Yield (%) |
|---|---|---|
| 1 | 587.6 | 88.2 |
| 2 | 577.5 | 86.6 |

### Synthesis of methyl 3-bromomesitoate (BME)

Potassium hydroxide pellets (36.0 g, 0.64 mol) were ground with a mortar and pestle to a fine powder and added to a 1 L round-bottom flask followed by dimethyl sulfoxide (DMSO) (360 mL). The mixture was vigorously stirred for 30 min. BMA (104.4 g, 0.43 mol) was separately dissolved in DMSO (360 mL) and then added to the basic DMSO mixture, stirring for 15 min at room temperature. Iodomethane (40 mL, 0.64 mol) was then slowly added to the mixture (exothermic, temperature was kept below 40° C.) and then stirred closed for 2 h at room temperature. The mixture was then poured into 5 L of stirring ice-water and left stirring at room temperature until all of the ice melted. The precipitate was collected by vacuum filtration, thoroughly washed with water, and dried under vacuum at room temperature for at least 24 h to produce 106.1 g of BME as white crystals (96.4% yield). ¹H NMR (400 MHz, DMSO-d₆, ppm) δ: 7.12 (s, 1H), 3.85 (s, 3H), 2.34 (s, 3H), 2.26 (s, 3H), 2.15 (s, 3H). The above procedure represents a “1.0 Scale”. For repeated syntheses, “2.0 Scale” represents the procedure being performed twice simultaneously and the final collected precipitates being combined prior to drying. The resulting data is shown in Table 2.

TABLE 2
Yield of BME and respective reaction scale for each reaction performed.

| Reaction # | Scale | Yield (g) | Yield (%) |
|---|---|---|---|
| 1 | 1.0 | 106.1 | 96.4 |
| 2 + 3 | 2.0 | 218.4 | 99.2 |
| 4 + 5 | 2.0 | 214.8 | 97.5 |
| 6 + 7 | 2.0 | 219.2 | 99.5 |
| 8 + 9 | 2.0 | 218.9 | 99.4 |
| 10 + 11 | 2.2 | 246.3 | 99.4 |

Monomer (HMTE) Synthesis

To the 5 L reactor was added 1,4-dioxane (2.9 L), BME (150.0 g, 0.58 mol), 1,4-phenylenediboronic acid (48.4 g, 0.29 mol), and 2 M K₂CO₃ (950 mL). The reactor was connected to a water-cooled condenser and the mixture was degassed by bubbling argon through a needle sub-surface for 1 h. The needle was removed and Pd(PPh₃)₄ (1.80 g, 0.27% mol per BME) was added under a flow of argon. The circulator temperature was set to 105° C. and the solution was mechanically stirred at 280 rpm for 22 h, where the internal temperature read 89° C. The dark yellow solution was then cooled to 60° C. and transferred by liquid transfer pump equally into 4×4 L beakers, each containing boiling and stirring 43% ethanol (2.62 L, aq.). The mixtures were stirred until they reached room temperature. The dark grey precipitates were collected by vacuum filtration and washed with water. The solid was dissolved in dichloromethane (1.0 L), washed with water (300 mL), and passed through a thick silica pad (˜300 g). More dichloromethane (˜4 L) was used to flush the silica and the filtrate was then evaporated by rotary evaporation to a pale yellow solid. The solid was then recrystallized in hexanes (5 L) by boiling until dissolved and cooling to ˜14° C. overnight. The white crystals were collected by vacuum filtration, washed with hexanes (400 mL), and dried under vacuum at 110° C. to yield 68.0 g of HMTE as fluffy, pure white crystals (54% yield). ¹H NMR (400 MHz, CDCl₃, ppm) δ: 7.15 (s, 4H), 7.00 (s, 2H), 3.92 (s, 6H), 2.33 (s, 6H), 2.03 (dd, J=9.0, 4.3 Hz, 12H). ¹³C NMR (100 MHz, CDCl₃, ppm) δ: 171.12, 139.82, 139.07, 137.72, 133.46, 132.82, 132.81, 132.30, 132.28, 129.48, 129.18, 129.17, 52.07, 21.04, 21.00, 19.57, 18.19, 18.15. The above procedure represents a “1.0 Scale”. For repeated syntheses, “Scale” represents an appropriately scaled version of all reactants and solvents by that factor. The amount of catalyst used was lowered for each subsequent reaction. The resulting data is shown in Table 3.

TABLE 3
Yield of HMTE, reaction scale, and amount of Pd(PPh₃)₄ used for each
reaction performed.

| | | Pd(PPh₃)₄ used | | Yield |
|---|---|---|---|---|
| Reaction # | Scale | (per mol % BME) | Yield (g) | (%) |
| 1 | 0.80 | 2.92 g (0.54%) | 55.6 | 55.3 |
| 2 | 1.00 | 1.80 g (0.27%) | 68.0 | 54.1 |
| 3 | 1.00 | 1.70 g (0.25%) | 70.8 | 56.4 |
| 4 | 1.00 | 1.51 g (0.22%) | 72.1 | 57.4 |
| 5 | 1.00 | 1.01 g (0.15%) | 72.2 | 57.5 |
| 6 | 1.00 | 0.79 g (0.12%) | 68.9 | 54.9 |
| 7 | 1.00 | 0.53 g (0.08%) | 71.9 | 57.3 |
| 8 | 1.17 | 0.77 g (0.10%) | 86.3 | 58.7 |

### Purification of 3,3′-diaminobenzidine (DAB)

A 2 L Erlenmeyer flask was filled with distilled water. The water was boiled while bubbling with argon. The bubbling of argon was stopped and then, using an inverted glass funnel, a low flow of argon was kept over the solution for the next steps. The as-received DAB (25.0 g) was added to the boiling water and stirred until dissolved. While boiling the solution, sodium dithionite (0.50 g) was added and stirred for 15 min. Activated charcoal (3.00 g) was then added and boiled for 30 min. The mixture was then quickly vacuum filtered through a hot funnel, producing a colorless filtrate. Argon was flowed through the filter flask and it was then kept sealed in the dark for 18 h. The resulting precipitate was then collected by vacuum filtration, washed with water, and quickly dried under vacuum at 100° C. The collected recrystallized DAB was stored in the dark under argon until use. The purification process was repeated on more as-received DAB from different companies and the resulting data is shown in Table 4.

TABLE 4
Yield of DAB after recrystallization and the respective appearance.

| | | DAB | | | |
|---|---|---|---|---|---|
| | | used | Yield | Yield | |
| Reaction # | Company^{a} | (g) | (g) | (%) | Appearance |
| 1 | 1 | 50.0 | 45.0 | 90.0 | white/sandy sheets |
| 2 | 1 | 50.0 | 42.8 | 85.6 | white/sandy sheets |
| 3 | 2 | 50.0 | 42.7 | 85.4 | long-pointed sandy-sheets |
| 4 | 2 | 50.0 | 42.3 | 84.6 | large sandy-sheets |
| 5 | 2 | 50.0 | 42.5 | 85.0 | small sandy sheets |
| 6 | 2 | 50.0 | 42.6 | 85.2 | very large pointed sandy |
| | | | | | sheets (glass shards) |
| 7 | 2 | 25.0 | 19.4 | 77.6 | largest pointed yellowish |
| | | | | | sheets (glass shards) |

^{a}from which company the DAB was purchased. Company 1 refers to TCI America and the DAB was received with 98% purity. Company 2 refers to Kindchem (Nanjing) Co., Ltd and the DAB was received with 98% purity.

Polymerization (HMT-PBI)

To a 1 L, 3-neck round-bottom flask was added HMTE (20.0000 g, 46.5 mmol), recrystallized DAB (9.9535 g, 46.5 mmol), and Eaton's reagent (800 mL, self-prepared). Argon was flowed into the flask and out through a CaCl₂ drying tube throughout the reaction. This mixture was heated at 120° C. until fully dissolved. After heating at 120° C. for 30 min, the temperature was increased to 140° C. for 20 min. The black solution was then slowly poured into distilled water (3.0 L) with manual stirring to break up the dense fibrous solid that formed. The solid was collected by vacuum filtration on glass fiber and washed with distilled water (1.5 L). The solid was then transferred to fresh distilled water (3.5 L) and the pH was adjusted to ˜10 by addition of potassium carbonate (˜70 g). The mixture was stirred overnight at room temperature. The solid was collected again, washed with water, boiling water, and acetone, and dried for at least 24 h at 100° C. to yield 26.0 g of HMT-PBI as fibrous solid (103% yield). The overestimated yield is likely due to trace water and acid in the fibrous solid, which will be later discussed. For ¹HNMR spectroscopy, HMT-PBI (˜13.0 mg) was dissolved in DMSO-d₆ (0.65 mL) by addition of KOD (5 drops of KOD 40 wt % in D₂O) and heating. ¹H NMR (400 MHz, DMSO-d₆, ppm) δ: 7.76-7.51 (m, 2H), 7.51-7.32 (m, 2H), 7.32-7.15 (m, 4H), 7.16-7.02 (m, 2H), 7.02-6.83 (m, 2H), 2.27-1.91 (m, 12H), 1.91-1.70 (m, 6H). For repeated syntheses, the same method above was used and the resulting data is shown in Table 5.

TABLE 5
Yield of HMT-PBI with the respective DAB batch used for each
reaction performed.

| | DAB | | | |
|---|---|---|---|---|
| Reaction # | batch | Yield (g) | Yield (%) | Appearance/Notes |
| 1 | 1 | 26.0 | 102.8 | off-white fibrous solid |
| 2 | 1 | 26.9 | 106.3 | off-white fibrous solid |
| 3 | 1 | 25.9 | 102.4 | off-white fibrous solid |
| 4 | 1 + 2 | 25.8 | 102.0 | off-white fibrous solid^{a} |
| 5 | 2 | 27.2 | 107.5 | off-white fibrous solid^{a} |
| 6 | 2 | 25.6 | 101.2 | off-white fibrous solid |
| 7 | 2 | 26.2 | 103.5 | thick off-white fibers^{b} |
| 8 | 2 + 3 | 25.6 | 101.2 | thick white fibrous solid |
| 9 | 3 | 25.5 | 100.8 | thick white fibrous solid |
| 10 | 3 | 25.4 | 100.4 | thick white fibrous solid |
| 11 | 3 | 26.2 | 103.5 | thick white fibrous solid |
| 12 | 3 + 4 | 25.8 | 102.0 | thick white fibrous solid |
| 13 | 4 | 25.7 | 101.6 | thick white fibrous solid |
| 14 | 4 | 27.3 | 107.9 | thick white fibrous solid^{c} |
| 15 | 4 | 24.7 | 97.6 | thick white fibrous solid^{c} |
| 16 | 4 | 25.3 | 100.0 | thick white fibrous solid |
| 17 | 4 + 5 | 25.5 | 100.8 | thin white fibrous solid |
| 18 | 5 | 25.5 | 100.8 | thin white fibrous solid |
| 19 | 5 | 25.7 | 101.6 | thin white fibrous solid |
| 20 | 5 | 25.4 | 100.4 | thin white fibrous solid |
| 21 | 5 + 6 | 25.6 | 101.2 | thin white fibrous solid |
| 22 | 6 | 26.2 | 103.5 | very thick white fibrous solid |
| 23 | 6 | 25.9 | 102.4 | very thick white fibrous solid |
| 24 | 6 | 26.4 | 104.3 | very thick white fibrous solid |
| 25 | 6 + 7 | 25.5 | 100.8 | very thick white fibrous solid |
| 26 | 7 | 25.7 | 101.6 | very thick white fibrous solid |

^{a}turned partially yellow after being left in air overnight when wet in acetone (not immediately dried).
^{b}polymer precipitated into ice-water rather than room temperature water.
^{c}these two samples were likely accidently mixed when collecting the solid, as they were performed side-by-side. Their average yield is 102.8%, which matches the total overall yield.

Procedure for ˜50% dm HMT-PMBI

To two separate 1 L, 3-neck round-bottom flasks was each added HMT-PBI (30.00 g, 55.1 mmol), DMSO (800 mL), and potassium hydroxide in water (14.00 g KOH in 35 mL H₂O). Each was vigorously stirred and heated at 70° C. for 16 h closed. The viscous dark red/brown mixtures were cooled to room temperature and both were combined by decanting into one 2 L beaker. While manually stirring the mixture with a glass rod, iodomethane (21.0 mL, 337 mmol) was added (exothermic). The dark-colored mixture was stirred for approximately 5 min until the mixture became a chunky, pale brown sludge. The mixture was then poured equally into 4×4 L beakers, each containing distilled water (3 L). To each beaker was then added potassium iodide (5.0 g) and briefly stirred with a glass rod. The precipitate was collected by vacuum filtration and washed with water. The collected cakes were transferred to a clean 4 L beaker and the cakes were beaten to a powder using a metal spatula. This wet solid was then stirred for 16 h in acetone (3 L) with potassium iodide (15.0 g). The solid was collected by vacuum filtration and washed with acetone. The yielded cakes were added to a 1 L container and beaten again to a powder. The solid was dried under vacuum at 80° C. for at least 24 h yielding 58.2 g of 53.7% dm HMT-PMBI as a pale brown powder (88.9% yield). ¹H NMR (400 MHz, CD₂Cl₂, ppm) δ: 8.28-7.45 (m, 6.03H), 7.44-7.09 (m, 6.00H), 4.46-3.87 (m, 0.91H), 3.87-3.39 (m, 5.61H), 2.33-1.97 (m, 11.71H), 1.97-1.70 (m, 7.39H). The amount of iodomethane used, the precipitation solvent, and amount of potassium iodide used was varied in subsequent reactions and the resulting data is shown in Table 6. The dm % was calculated using Equation (1), below.

TABLE 6
Yield of ~50% dm HMT-PMBI, reaction scale, amount of iodomethane
(MeI) used, and calculated dm % from ¹H NMR spectroscopy data
for each reaction performed.

| | | MeI | | | | |
|---|---|---|---|---|---|---|
| | | amount | | | | |
| Reaction | | used | Yield | Yield | | |
| # | Scale | (mL) | (g) | (%) | dm | Appearance |
| 1 | 0.83 | 13.8 | 44.0 | 79.3 | 55.6% | pale brown powder^{a} |
| 2 | 1.00 | 18.5 | 53.3 | 83.3 | 51.4% | pale brown powder^{b} |
| 3 | 1.00 | 20.0 | 52.7 | 79.7 | 54.9% | pale yellow powder^{b} |
| 4 | 1.00 | 22.0 | 54.4 | 83.1 | 53.8% | pale yellow powder^{c} |
| 5 | 1.00 | 22.0 | 58.6 | 88.2 | 55.3% | pale brown powder |
| 6 | 1.00 | 22.0 | 59.6 | 88.6 | 56.7% | brown powder |
| 7 | 1.00 | 21.0 | 58.2 | 88.9 | 53.7% | pale brown powder |
| 8 | 1.00 | 21.0 | 59.3 | 88.5 | 56.2% | brown powder |
| 9 | 1.00 | 21.0 | 58.7 | 89.1 | 54.5% | pale brown powder |
| 10 | 1.00 | 21.0 | 58.6 | 87.6 | 56.0% | brown powder |
| 11 | 1.00 | 21.0 | 59.1 | 90.2 | 53.9% | pale brown powder |

^{a}polymer was precipitated into water and no potassium iodide was used in the purification process.
^{b}polymer was precipitated into methanol and no potassium iodide was used in the purification process.
^{c}polymer was precipitated into methanol with potassium iodide. No potassium iodide was used in the acetone purification step.

Controlled Methylation Procedure

To a 1 L round-bottom flask containing dichloromethane (300 mL) was added ˜50% dm HMT-PMBI (34.00 g, 51.4% dm) followed by additional dichloromethane (400 mL). The solid was broken up inside with a spatula and the mixture was stirred for 1.5 h until mostly dissolved. Iodomethane (13.0 mL, 209 mmol) was added and the mixture was stirred for 18 h closed at 30° C. The precipitate was broken up with a spatula and the stirring was continued for 3 h at room temperature. The solvent was evaporated at 44° C. by dynamic vacuum, leaving a strong solid film stuck to the inner glass wall. Methanol was added and heated to dissolve the polymer and then transferred to a large, flat glass dish, using additional methanol to rinse all of the contents into the large dish. The solvent was evaporated in air at room temperature and then under vacuum at 100° C., yielding one thick 45.6 g brown film of 90.2% dm HMT-PMBI (97.2% yield). The ¹H NMR spectra were taken of washed and dried membranes. ¹H NMR (400 MHz, DMSO-d₆, ppm) δ: 8.97-7.66 (m, 6.15H), 7.66-7.04 (m, 6.00H), 4.30-3.78 (m, 9.57H), 3.78-3.50 (m, 1.16H), 2.44-1.49 (m, 17.88H). For repeated syntheses, the polymer was purified by different methods, such as precipitation into acetone rather than evaporation of dichloromethane. Additionally, if a lower than desired dm % was yielded, such as 86% dm instead of 89% dm, the same procedure could be repeated using DMSO as the solvent and a stoichiometric amount of iodomethane at 30° C. for 18 h. The resulting synthetic data is shown in Table 7. The dm % was calculated using Equation (1).

TABLE 7
Yield of >55% dm HMT-PMBI, amount of iodomethane (MeI) used,
reaction time, and dm % as calculated by ¹H NMR
spectroscopy data for each reaction performed.

| | MeI amount | | | | | |
|---|---|---|---|---|---|---|
| Reaction | used | Reaction | | Final | Yield | Yield |
| # | (mL) | time (h) | Initial dm | dm | (g) | (%) |
| 1^{a} | 10.5/0.6 | 16/19 | 55.6% | 89.2% | 31.6 | 70.6 |
| 2^{b} | 13.0 | 18 | 53.4% | 89.4% | 37.6 | 82.2 |
| 3 | 13.0 | 21 | 51.4% | 90.2% | 45.6 | 97.2 |
| 4 | 13.0 | 18 | 54.9% | 88.9% | 44.2 | 98.4 |
| 5 | 11.0 | 17 | 54.3% | 86.5% | 43.0 | 96.8 |
| 6 | 9.0 | 17 | 53.8% | 82.8% | 42.7 | 98.4 |
| 7^{c} | 18.0 | 90 | 55.3% | 97.0% | 47.2 | 99.7 |

^{a}this reaction followed a two-step methylation process. The first methylation was performed in dichloromethane (DCM) for 16 h and the second methylation in DMSO for 19 h. The polymers were collected by precipitation.
^{b}polymer was collected by precipitation into acetone containing potassium iodide.
^{c}the initial MeI amount was 13.0 mL but was increased to 18.0 mL after 48 h and continued for a total of 90 h.

Determination of Dm

The degree of methylation (dm) for polymers possessing >55% dm was calculated as previously reported. Specifically, using the baseline corrected (MestReNova, “Full Auto Polynomial Fit”)¹H NMR spectrum of >55% dm HMT-PMBI (400 MHz, DMSO-d₆), the integration region 4.30-3.78 ppm was set to 12.00H and the respective integration for 3.78-3.50 ppm was calculated to be x. The dm % was then calculated using equation (1).

$$dm \% = 50 ( \frac{1}{1 + \frac{x}{6}} ) + 50 \qquad Equation ( 1 )$$

Also using equation (1), the dm % for ˜50% dm HMT-PMBI was calculated from its ¹H NMR spectrum (400 MHz, CD₂Cl₂), where the integration of 4.46-3.87 ppm was set to 12.00H and the respective integration for 3.87-3.39 ppm was calculated to be x.

Membrane Fabrication

HMT-PMBI (89% dm, iodide form, 3.5 g) was dissolved in DMSO (46.67 g) by stirring and gently heating for 12 h. The polymer solution was vacuum filtered through glass fibre at room temperature, cast on a levelled glass plate using a K202 Control Coater casting table and a doctor blade (RK PrintCoat Instruments Ltd) and stored in an oven at 85° C. for at least 12 h. The membrane peeled off the glass plate upon immersion in distilled water. After soaking the membrane in distilled water (2 L) for 24 h, the membrane was dried under vacuum at 80° C. for 24 h.

Water Uptake

HMT-PMBI membranes were soaked in corresponding 1 M aqueous MX solutions at room temperature for 48 h (exchanged twice), where MX represents KF, KCl, KBr, KI, Na₂SO₄, KOH, KHCO₃, K₂CO₃, or HCl. The membranes were washed with deionized (DI) water several times and soaked in DI water for another 48 h at room temperature (with three exchanges of water) in order to remove trace salts from the membrane. A fully hydrated (wet) membrane was removed and weighed (W_{w}) immediately after excess water on the surface was removed with tissue paper. The hydrated membrane was dried under vacuum at 40° C. to a constant dry weight (W_{d}). The water uptake (Wᵤ) was calculated using equation (2) below.

$${W}_{u} ( \% ) = \frac{{W}_{w} - {W}_{d}}{{W}_{d}} \times 100 \qquad Equation ( 2 )$$

Dimensional Swelling

The procedure for determining dimensional swelling was analogous to determining water uptake wherein the wet dimensions (D_{w}) and dry dimensions (D_{d}) were measured. The percent directional dimensional swelling (Sₓ, S_{y}, and S_{z}) was calculated by using equation (3)

$${S}_{x , y , or z} ( \% ) = \frac{{D}_{w} - {D}_{d}}{{D}_{d}} \times 100 \qquad Equation ( 3 )$$

where Sₓ represents the dimensional swelling in the x-direction (length-direction). D_{w} and D_{d} represent the dimensions of the x-direction of the wet and dry membrane, respectively. S_{y} and S_{z} represent the dimensional swelling in the y- and z-directions (width and thickness), respectively, using their respective D_{w} and D_{d} values in the y- and z-directions. The percent volume dimensional swelling (Sᵥ) was calculated using equation (4)

$${S}_{v} ( \% ) = \frac{{V}_{w} - {V}_{d}}{{V}_{d}} \times 100 \qquad Equation ( 4 )$$

where V_{w} and V_{d} represent wet and dry volumes, determined from the products of the x-, y-, and z-dimensions D_{w} and D_{d}, respectively.

Ionic Conductivity

The ionic resistance of membranes in the in-plane direction of a two-point probe was measured using electrochemical impedance spectroscopy (EIS), performed by applying an AC potential over a frequency range 10²-10⁷ Hz with a Solartron SI 1260 impedance/gain-phase analyzer. Unless otherwise noted, the conductivity was measured for fully hydrated membranes at ambient temperature (˜22° C.). The membrane resistance (R) was determined from the corresponding ionic resistance calculated from a best fit to a standard Randles circuit of the resulting data. The ionic conductivity (o) was calculated by using equation (5)

$$σ = \frac{l}{AR} \qquad Equation ( 5 )$$

where l is the distance between the two electrodes and A is the cross-sectional area of the membrane.

For measuring mixed hydroxide/bicarbonate/carbonate ionic conductivities under controlled temperature and relative humidity (RH) conditions, two membranes were first soaked in argon-degassed 1 M KOH for 48 h. The membranes were then washed with degassed DI water for 24 h. After the surface water was removed with tissue paper, the membrane was mounted on a two-point probe inside a pre-set humidity chamber (Espec SH-241) and left to equilibrate in air for 16 h. At a given humidity, the temperature was increased in 10° C. increments, and the membrane equilibrated for 30 min before measuring the resistance. When the humidity was changed, the cell was allowed to equilibrate for 2 h before the first measurement. The average of the two membrane conductivities is reported.

Anion Concentration

The anion concentration, [X⁻], in HMT-PMBI membranes was calculated using equation (7), wherein IEC_{X}- was calculated using equation (8).

$$[ {X}^{-} ] = \frac{{IEC}_{{X}^{-}} \cdot {w}_{dry}}{{V}_{wet}} \qquad Equation ( 7 )$$

Here, IEC_{X}- is the IEC of HMT-PMBI in the X⁻ form, w_{dry} is the dry weight of the membrane in the X⁻ form, and V_{wet} is the wet volume in the X⁻ form. The anion concentration in OH⁻, HCO₃⁻, and CO₃²⁻ forms were calculated using the IEC of HMT-PMBI in the HCO₃⁻ form.

$${IEC}_{{X}^{-} } = \frac{4000 ( dm - 0.5 )}{{MR}_{100} \cdot 2 ( dm - 0.5 ) + {MR}_{50} ( 1 - 2 ( dm - 0.5 ) )} \qquad Equation ( 8 )$$

In equation 8, dm is the degree of methylation (0.89 if dm=89%), MR₁₀₀ is the molar mass of one repeat unit of 100% dm HMT-PMBI (including the two X⁻ counter ions), and MR₅₀ is the molar mass of one repeat unit of 50% dm HMT-PMBI.

Mechanical Strength

The membranes were die-cut to a barbell shape using a standard ASTM D638-4 cutter. The mechanical properties of the membranes were measured under ambient conditions on a single column system (Instron 3344 Series) using a crosshead speed of 5 mm min⁻¹. The determined tensile strength, Young's moduli, and elongation at break were averaged over three samples. The error reported is the standard deviation. To convert from the as-cast iodide form to the chloride form, the membrane was soaked in 1 M NaCl for 48 h (exchanged twice), soaked in DI (deionized) water for 48 h (with multiple exchanges), and dried at 80° C. under vacuum for 16 h.

Chemical Stability

A model compound of the polymer, 2-mesityl-1,3-dimethyl-1H-benzimidazolium iodide (BMIM-I⁻) (83 mg), was dissolved in a 2.0 mL mixture of 10 M KOH_{aq} with 3.0 mL methanol (resulting in a 4 M KOH solution). The mixture was heated to 80° C. for 7 days. After cooling to room temperature, a red solid was collected by filtration, washed with water, and dried under vacuum at 60° C. The solid was dissolved in DMSO-d₆ and analyzed by ¹H NMR spectroscopy.

Prior to testing the chemical stability of HMT-PMBI in various ionic solutions, the as-cast iodide form was converted to the chloride form by soaking the membrane in 1 M NaCl for 48 h (exchanged twice) and then in DI water for 48 h (multiple fresh exchanges). The membrane was subjected to degradation tests using various conditions in closed HDPE containers. Following the degradation test, the membrane was re-exchanged back to chloride form by soaking in 1 M NaCl for 48 h (exchanged twice) and then in DI water for 48 h (multiple fresh exchanges). The ionic conductivity of this membrane in its wet form was measured and the membrane was dried at 50° C. for 16 h. Membrane pieces were dissolved in DMSO-d₆ (25 g L⁻¹ concentration) and analyzed by ¹H NMR spectroscopy. The relative amount of benzimidazolium remaining was calculated from the ¹H NMR spectral data using equation (9)

$$Remaining ( \% ) = ( \frac{1 - \frac{y}{2}}{1 - \frac{z}{2}} ) \times 100 \qquad Equation ( 9 )$$

where y represents the integration area between 6.00-4.35 ppm relative to 12.00H for the 9.20-6.30 ppm area for the sample of interest and z represents the integration area between 6.00-4.35 ppm relative to 12.00H in the 9.20-6.30 ppm region for the initial sample.

Assembly of the Catalyst-Coated Membrane

An HMT-PMBI membrane (89% dm) was first exchanged from iodide to chloride form by immersion in 1 M KCl for 7 days followed by soaking in DI water for two days with one fresh exchange of DI water half-way through. The chloride form HMT-PMBI was dissolved in MeOH to form a 10 wt % ionomer dispersion. Separately, a catalyst mixture was prepared by adding water followed by methanol to commercial carbon-supported Pt catalyst (46.4 wt % Pt supported on graphitized C, TKK TEC10E50E). The ionomer dispersion was added drop-wise to the catalyst mixture while the solution was rapidly stirred. This resulting catalyst ink contained 1 wt % solids in solution and a 3:1 (wt/wt) MeOH:H₂O ratio. The solids comprised of 15 wt % HMT-PMBI (Cl⁻) and 85 wt % Pt/C. 15 wt % HMT-PMBI (I⁻) catalyst ink was similarly produced from the iodide form. 25 wt % FAA-3 (Br⁻) catalyst ink was similarly produced using commercial ionomer dispersion (FAA-3, 10 wt % in NMP).

To form the catalyst-coated membrane (CCM), a membrane was fixed to a vacuum table at 120° C. The HMT-PMBI (Cl⁻) membrane thickness used for the AEMFC testing was 34±2 μm; for the water electrolysis, it was 43±2 μm. The commercial membrane (FAA-3, Br⁻) thickness used for the AEMFC testing was 20 gim; for the water electrolysis, it was 50 μm. The prepared catalyst ink was applied using an ultrasonicating spray-coater (Sono-Tek ExactaCoat SC) to create a 5 cm² electrode area with cathode/anode catalyst loadings of 0.4/0.4 mg Pt cm⁻² for the AEMFC or 0.5/0.5 mg Pt cm⁻² for the water electrolyzer. The HMT-PMBI (Cl⁻) CCM was then immersed in 1 M KOH in a sealed container for 7 days and DI water for 24 h in a sealed container. FAA-3 CCMs were non-operational after this process and the FAA-3 CCM was instead immersed in 1 M KOH for 24 h. For comparison, the HMT-PMBI (I⁻) CCM were exchanged in 1 M KOH for 24 h. Gas-diffusion layers (GDL, Sigracet 24BC) were applied to the electrodes and gasketing of a specific thickness was chosen to achieve a 20-30% GDL compression. The resultant assembly was torqued to 2.26 N m. Alignment and adequate compressions were confirmed by using a pressure-sensitive film (Fujifilm Prescale LLLW). For water electrolysis, CCMs were mounted in a fuel cell hardware modified for alkaline electrolyte stability, which included Ti flow fields. CCMs were laminated, and a 50 μm thick Ti screen (60% open area) was applied to the electrodes, with gasketing that was sufficient to provide a zero gap between the flow field, Ti screen, and the electrode. CCMs were mounted directly in situ.

AEMFC Operation

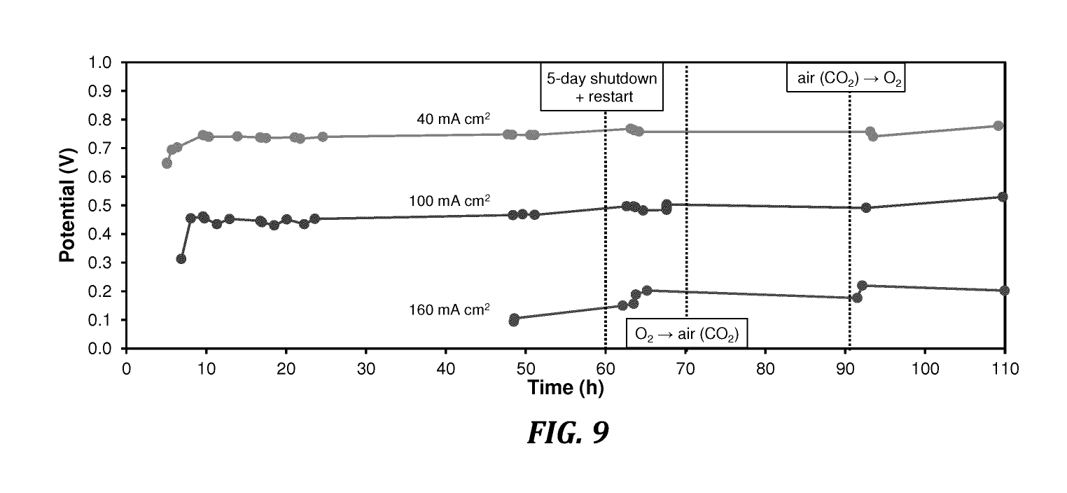

The resultant HMT-PMBI (Cl⁻) AEMFC was conditioned at 100 kPa_{abs} and 60° C. under 100% RH and H₂/O₂ and subsequently operated at 300 kPa_{abs}. The potential and resistances measured stabilized for current densities >100 mA cm⁻² after 8 h operation. The CCM was conditioned by running multiple, slow polarization sweeps. The current was increased stepwise from open circuit voltage (OCV) at a rate of 10 mA cm⁻² per 5 min up to a 0.15 V cut-off. Over the operation time of the AEMFC, multiple sets of polarization data were taken at 5 min pt⁻¹ from OCV at 5 or 10 mA cm⁻² intervals to a 0.2 V cut-off, with additional 1 min pt⁻¹ steps at 2 mA cm⁻² intervals between 0-20 mA cm⁻² in order to resolve the kinetic polarization region. Multiple fuel cells were constructed and tested under different conditions. In the fuel cell test presented here, the fuel cell was subjected to a 5-day shutdown after 60 h of operation, and then restarted for an additional 10 h (see FIG. 9). At 70 h of total operation, CO₂-containing air was used as the gas feed for 21 h (70-91 h time period) rather than pure O₂ in order to examine fuel cell operation using ambient air, before returning the gas feedback to pure O₂. During the following 109-114 h operational time using pure oxygen, the temperature was increased to 70° C. for 1 h and then increased in 5° C. intervals to 90° C. The same conditioning procedures and conditions were used for FAA-3 membranes and HMT-PMBI (I⁻) membranes for comparison. For operation using 100 kPa_{abs}, polarization data was taken at 5 s pt⁻¹. A diagram of the experimental setup is shown in FIG. 2.

Water Electrolyzer Operation

The water electrolyzer used a 1 M KOH circulating electrolyte flow heated to 60° C., separately supplied to the anode and cathode at a rate of 0.25 mL min⁻¹. A diagram of the experimental setup is illustrated in FIG. 3. The electrolyte was circulated for 1 h prior to electrolysis to ensure the polymer within the CCM was converted to the hydroxide form. 20 mA cm⁻² was drawn from the FAA-3 based cell and 25 mA cm⁻² was drawn from the HMT-PMBI based cell, using a Solartron SI 1260. The experiment was terminated for FAA-3 cells when the applied potential reached 3 V or fell below 1.2 V, corresponding to two different modes of cell failure, as reported in literature. The hydrogen evolution reaction (HER) and oxygen evolution reaction (OER) current density attributable to the Ti screens was measured ex situ in 1 M KOH potentiodynamically, and accounted for <0.1 mA cm⁻² in this potential range. Rates of hydrogen and oxygen gas evolution were also observed by inspection.

Results

The scaled-up synthesis of HMT-PMBI was performed on multiple smaller scale setups, in either a 5 L reactor or a 1 L round-bottom flask. The average yields and standard deviations for multiple syntheses are shown in Scheme 1. The quantities shown are the total used (u) or the yield obtained (y).

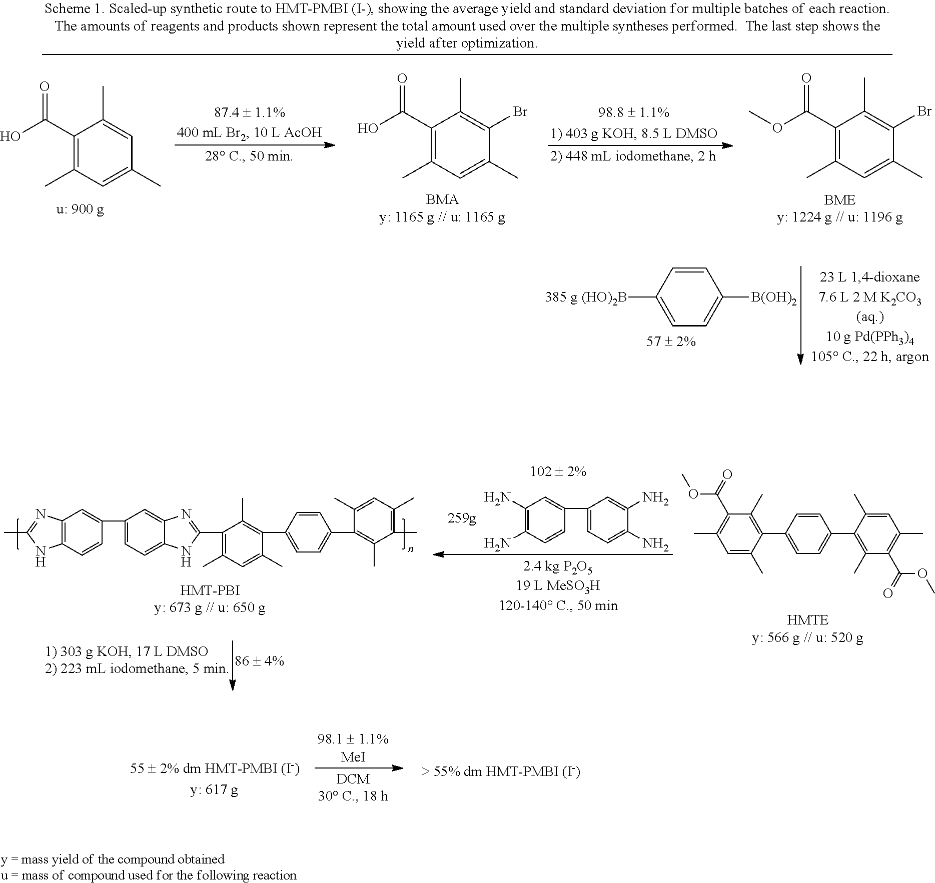

The synthetic route used mesitoic acid (900 g, 5.5 moles) which was readily brominated to yield BMA in high yield (87.4±1.1%, 4 runs, 5 L scale). This yield was significantly higher than the original reported 60% yield and previously reported yield of 74%. The yield was found to increase when excess bromine was used rather than a stoichiometric amount, as dibromination was not observed to be significant at 25° C. The second step involved methylation of BMA to BME, which was achieved in near-quantitative yield (98.8±1.1%, 11 runs, 1 L scale).

The third step involved Suzuki coupling of BME with 1,4-phenylenediboronic acid to form monomer HMTE, which was reproduced in 57±2% yield (8 runs, 5 L scale). The amount of catalyst, Pd(PPh₃)₄, was varied in each run, initially starting with 0.54% mol catalyst per BME. The amount of catalyst was decreased to as low as to 0.08% mol catalyst per BME without any reduction in yield. High purity HMTE was obtained from every batch, as judged by their indistinguishable 1H NMR spectra.

In contrast to the originally reported synthesis of HMT-PMBI, where monomer HMTE was hydrolyzed to its diacid form and then polymerized, polymer HMT-PBI was obtained directly from monomer HMTE. The original hydrolysis route involved dissolving HMTE in concentrated sulfuric acid and precipitating into water. However, as the polymerization to HMT-PBI involves Eaton's reagent (7.7 wt % P₂O₅ in methanesulfonic acid), the hydrolysis was found to occur in situ, thus eliminating the need for a specific hydrolysis step, and reducing the polymer synthesis by one step. The monomer, DAB, which was purchased from more than one company and having different purities, was recrystallized prior to every polymerization in order to ensure uniform DAB purities and thus reproducible polymers (Table 4).

HMT-PBI was produced with a theoretical yield of 102±2% (26 runs, 1 L scale). The over-estimated yield is most likely due to residual acid present in the polymer fibers. While there were small differences in color and thickness of the precipitated polymer fibers from batch to batch (Table 5), the ¹H NMR spectra show there are no visible differences in the expected resonances. Due to the negligible variability of each batch, batches were combined, blended, and ground into a saw-dust-like powder using a 700 W blender and mixed together in a 12 L vessel.

The following partial methylation procedure of HMT-PBI to ˜50% dm HMT-PMBI was varied throughout the repeated syntheses in order to optimize the yield and decrease the purification time. For example, the average yield of batches 1-4 and 5-11 were 81±2% and 88.7±0.5%, respectively (see Table 6). This significant increase in yield was due to the addition of potassium iodide in the purification of the polymer in batches 5-11. For example, when the polymer was precipitated from DMSO into water, its amphiphilic nature caused it to partially dissolve, due to its over-methylation of 55±2% dm. The addition of potassium iodide prevents the polymer from dissolving without potentially exchanging the counter-ion, for example, to chloride, if sodium chloride was used instead. This lowers the time needed to filter the polymer for batches 5-11, which also possessed significantly less solvent impurities than the initial batches, and is likely due to the ability to better wash the filtered polymers. An unassigned peak in all of the ¹H NMR spectra of ˜50% dm HMT-PMBI (400 MHz, CD₂Cl₂) polymers was observed at 0.13 ppm, which may be due to methylated silicates arising from the hot KOH-DMSO solution that etches the glass walls of the reactors. This suggests that non-glass reaction vessels would perform better for repeated large scale batches.

The final synthetic step was the controlled methylation of ˜50% dm to >55% dm HMT-PMBI in dichloromethane, which was achieved in near-quantitative yield (98.1±1.1%) over a range of dm %. The original procedure involved the precipitation of the ionene from the dichloromethane solution into acetone, but this procedure led to a 20-30% loss in yield. Instead, evaporation of the dichloromethane resulted in nearly quantitative yield for all degrees of methylation. While a number of polymer batches of >55% dm HMT-PMBI were prepared in order to show the extent of control and reproducibility, only those polymers with 89% dm were subjected to characterization and stability tests. The choice of 89% dm can provide membranes with balanced ionic conductivity, water uptake, and mechanical strength.

The overall synthetic yield, based on the starting mesitoic acid to >55% dm HMT-PMBI was 42±3%, which is high for a six-step synthesis. Each step showed high reproducibility in terms of yield, as well as purity. The synthesis of 617 g of 55±2% dm HMT-PMBI, which corresponds to 1.03 mol repeat units, demonstrates the versatile scale up of this synthetic route.

Hydroxide Ion Conductivity

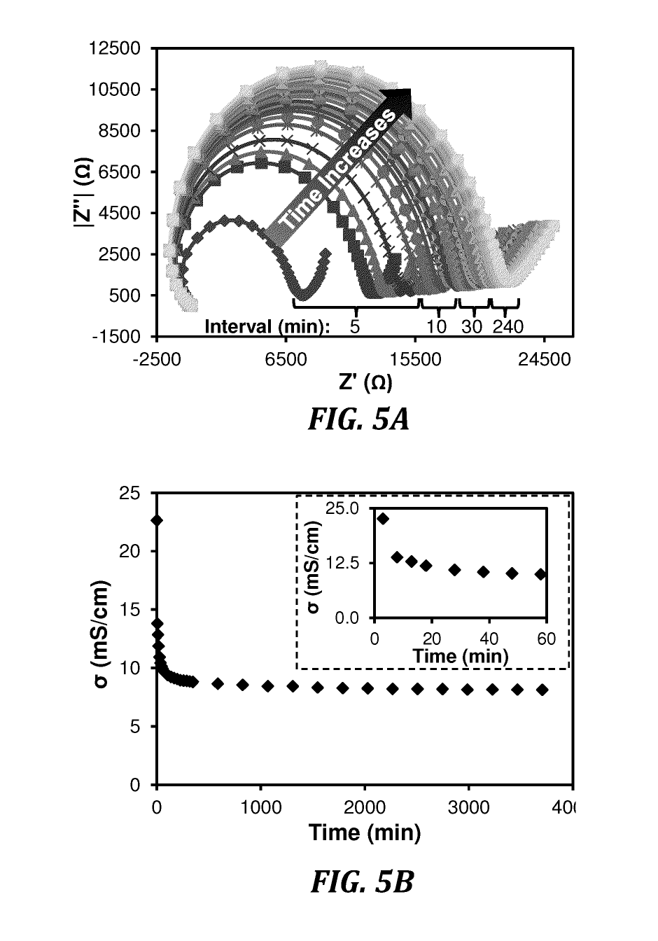

The as-cast 89% dm HMT-PMBI (I⁻) membrane was converted to hydroxide form by immersion into 1 M KOH for 48 h, followed by washing with argon-degassed water several times. By immediately monitoring, the ionic conductivity of the wet membrane was measured by electrochemical impedance spectroscopy (EIS) in air (FIGS. 5A and 5B). The initial conductivity of 23 mS cm⁻¹ decreased rapidly upon exposure to air and leveled off at 8.1 mS cm⁻¹ after ˜40 min, as shown in FIG. 5B. This effect is attributed to rapid conversion of hydroxide to a mixed hydroxide/bicarbonate/carbonate form upon exposure to CO₂ in the atmosphere.

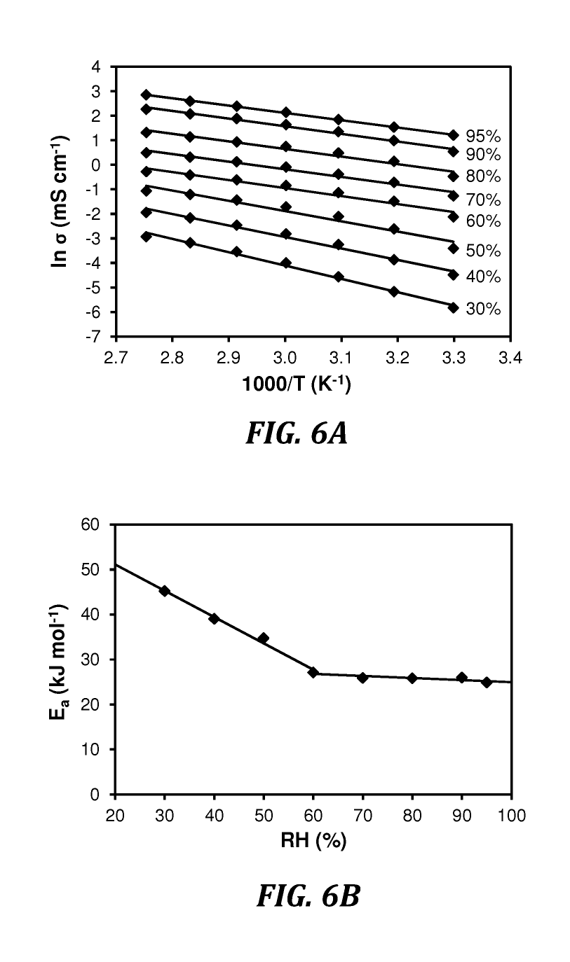

Accordingly, after 16 h equilibration in air, the mixed carbonate conductivity was measured at various temperatures and relative humidity (RH), which followed Arrhenius-type behavior, as shown in FIG. 6A. The highest conductivity was measured at 95% RH and 90° C. to be 17.3 mS cm⁻¹. The activation energies (Eₐ) were calculated at each humidity level using Eₐ=−mR, where m represents the slope of the linear regression for ln σ vs. 1000/T and R represents the universal gas constant (8.314 J mol⁻¹ K⁻¹). Between 70-95% RH, Eₐ was calculated to be 25-26 kJ mol⁻¹, which is typical for bicarbonate AEMs. However, as the RH was decreased below 60%, the activation energy linearly increased, as shown in FIG. 6B, possibly due to the loss of accessible cationic sites that are immobilized in the backbone. This suggests that an RH of at least 60% is required to hydrate the polymer for unhindered bicarbonate conduction.

Physical Properties of HMT-PMBI Incorporating Various Anions

The water uptake (Wᵤ), volume dimensional swelling (Sᵥ), and directional swelling (Sₓ, S_{y}, and S_{z}) were measured for 89% dm HMT-PMBI after soaking for 48 h in various 1 M ionic solutions, to exchange the anion, and washed with water for 48 h.

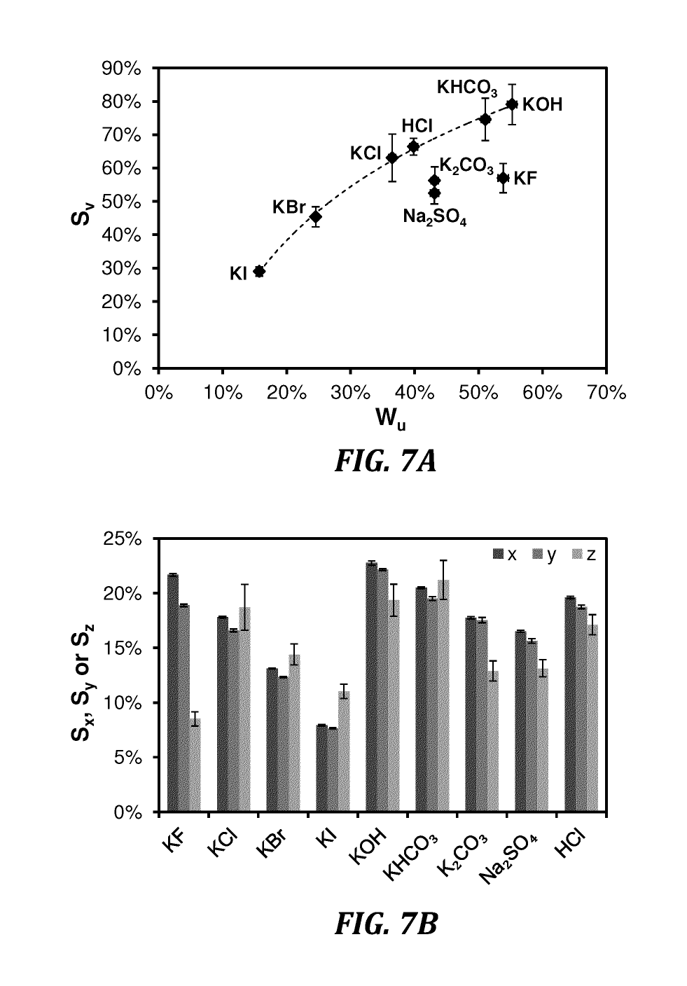

The resulting water uptake and swelling are shown in FIGS. 7A and 7B. FIG. 7A illustrates a proportional relationship between dimensional swelling and water uptake for the monovalent anions, with the exception of the fluoride ion form. Dimensional swelling increased in the order of I⁻<Br⁻<F⁻<Cl⁻<OH⁻. This unusual behavior of the fluoride form is more clearly observed in plots of directional swelling (FIG. 7B), where KF results in significant anisotropic swelling. The fluoride form swells by almost three times more in each in-plane direction compared to the out-of-plane (S_{z}) whereas the other halogens exhibit minor increases in thickness relative to in-plane swelling. The relative decrease in swelling in the thickness direction of the fluoride ion form is similar to that of the bivalent anions (CO₃²⁻and SO₄²⁻), which have the ability to ionically-crosslink the polymer. The observed anisotropic dimensional swelling of the fluoride ion form may be due to the anisotropic orientation of the polymers, i.e., aligning parallel to the in-plane direction, due to the slow evaporation process during casting, but this would require further study for validation.

The conductivity of wet membranes of each ion form is shown in Table 8. The highest conductivity was observed for membranes ion-exchanged using KOH solution; exchange with KCl produced a membrane with the second highest conductivity. The conductivity differences between KOH, KHCO₃, and K₂CO₃ were larger than expected, as each ion is known to equilibrate to a similar mixed carbonate form in air. A possible reason is due to the mechanical changes that occur due to different swelling behavior in the various ionic solutions, as previously shown in FIGS. 7A and 7B.

The differences in conductivity of membranes containing different anions does not correlate to the corresponding diffusivity coefficient of the anion at infinite dilution, D, listed in Table 8. For example, the diffusivity coefficient at infinite dilution is similar for Cl⁻, Br⁻, and I⁻, but the conductivity decreases in the order of Cl⁻>Br⁻>I⁻. This trend is likely due to differences in water uptake and differences in dimensional swelling of the membranes, the effect of an anion possessing different dissolution enthalpies, and the fact that the anions are far from being at infinite dilution—the anion concentration in the membrane is in the order of 1.5-2 M (Table 8). This brings into question the validity of using D values to estimate hydroxide conductivities based on mixed carbonate forms (ratio of 3.8) or chloride forms of the polymer, which have been previously used in the literature to draw comparisons between anions.

TABLE 8
Diffusion coefficients at infinite dilution of anions and the respective
anion conductivity and anion concentration of HMT-PMBI.

| | anion D | σ_{X}- | [X⁻] |
|---|---|---|---|
| Solution | (×10⁵ cm² s⁻¹)^{a} | (mS/cm)^{b} | (M)^{c} |
| KF | 1.48 | 6.2 ± 0.2 | 1.86 ± 0.10 |
| KCl | 2.03 | 7.5 ± 0.4 | 1.7 ± 0.2 |
| KBr | 2.08 | 4.2 ± 0.6 | 1.89 ± 0.09 |
| KI | 2.05 | 0.87 ± 0.01 | 2.04 ± 0.07 |
| KOH | 5.27 | 10.0 ± 1.2 | 1.51 ± 0.07 |
| KHCO₃ | 1.19 | 3.8 ± 0.4 | 1.57 ± 0.09 |
| K₂CO₃ | 0.92 | 2.0 ± 0.2 | 1.69 ± 0.12 |

^{a}Literature data for diffusion coefficients (D) of anions in aqueous solution at 25° C.
^{b}Anion conductivity (σ) of 89% dm HMT-PMBI membranes after anion exchange in 1M solutions at room temperature.
^{c}Anion concentration in HMT-PMBI at room temperature.

The ability of the hydroxide ion to convert to the mixed carbonate form makes the measurement of the hydroxide conductivity form unreliable. As a result, measurements pertaining to degradation tests and mechanical properties of HMT-PMBI after exposure to different aggressive conditions, were reconverted to the chloride form, as the chloride form exhibits the next closest properties to the hydroxide ion form, yet is stable in air.

Mechanical Strength

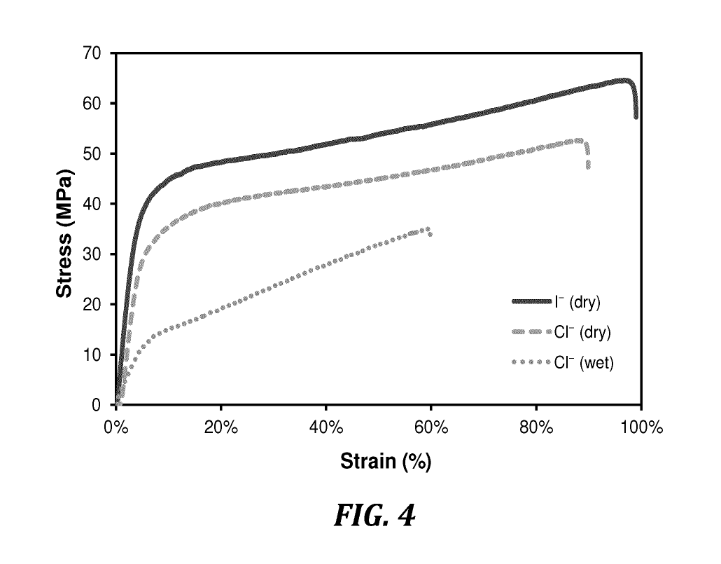

Tensile strength, elongation at break, and the Young's modulus were measured for 89% dm HMT-PMBI membranes using either the as-cast iodide form or the chloride-exchanged membrane (FIG. 4). Three measurements were performed on each form and their properties are tabulated in Table 9. The tensile strength of the as-cast HMT-PMBI membrane (I⁻, dry) was measured to be 64.7±0.3 MPa, equivalent to the high performance polymer, m-PBI, which has a similar backbone. However, the elongation of 89% dm HMT-PMBI (97±13%) is higher than m-PBI by two orders of magnitude, and its Young's modulus is lower. From these data, HMT-PMBI is viewed as being exceptionally strong and flexible for an ionic solid polymer electrolyte. The tensile strength of the dry polymer decreased when the iodide was exchange for chloride form, and furthermore decreased when in a wet state, which is attributed to the increased water uptake and dimensional swelling of the chloride forms, as previously shown. Nevertheless, the wet chloride form possessed a significantly higher tensile strength, a lower elongation at break, and a similar Young's modulus to that of a commercial ion-exchange membrane, Nafion 212, illustrating that HMT-PMBI exhibits robust mechanical properties, potentially suitable for fuel cell or water electrolyzer applications.

TABLE 9
Mechanical properties of HMT-PMBI membranes compared to that of
Nafion 212 and m-PBI

| | | | | HMT- | HMT- | HMT- |
|---|---|---|---|---|---|---|
| Mechanical | Nafion 212 | Nafion 212 | m-PBI | PMBI | PMBI | PMBI |
| Property^{d} | (dry) | (wet) | (dry) | (I⁻, as-cast) | (Cl⁻, dry) | (Cl⁻, wet) |
| Tensile Strength | 23.9^{a} | 19.4^{a} | 65^{b} | 64.7 ± 0.3 | 50 ± 2 | 33 ± 3 |
| (MPa) | | | | | | |
| Elongation at break | 136^{a} | 119^{a} | 2^{b} | 97 ± 13 | 76 ± 10 | 63 ± 5 |
| (%) | | | | | | |
| Young's Modulus | 270^{a} | 200^{a} | (5900)^{c} | 1070 ± 160 | 940 ± 40 | 230 ± 30 |
| (MPa) | | | | | | |

^{a}Literature data for a membrane.
^{b}Literature data for a membrane.
^{c}Literature data for a fibre.
^{d}Mechanical properties for HMT-PMBI membranes (89% dm) were measured three times and the standard deviations are shown. The chloride form was produced by exchanging the as-cast iodide membranes in 1M NaCl.

Ex Situ Stability to Hydroxide Ions

The model compound, 2-mesityl-1,3-dimethyl-1H-benzimidazolium (MBIM) (Scheme 2), was subjected to 4 M KOH/CH₃OH/H₂O at 80° C. for 7 days in order to observe the ¹H NMR spectrum of the degradation product without the complicated side-products from deuterium exchange. The precipitated, dark red-colored degradation product was collected and analyzed by ¹H NMR spectroscopy. The main degradation pathways reported in literature are nucleophilic displacement (Scheme 2, arrow a) and ring-opening degradation (Scheme 2, arrow b) followed by hydrolysis (Scheme 2, arrow c). It has been recently shown that MBIM degrades only by ring-opening when in 3 M NaOD/CD₃OD/D₂O at 80° C., which agrees well with the spectrum of the degraded product. There appears to be more than one isomer, which results in multiple peaks within a given area. For example, the N—H peaks appear between 5.4-4.4 ppm but only one quartet peak was expected. Two quartets are instead observed, suggesting that conjugation through the amide bond locks rotation on the NMR time scale, observing trans- and cis-like compounds simultaneously. The conjugation is also the likely reason for the dark red color of this product.

Scheme 2.

Possible degradation pathways for the model compound in hydroxide solution: (arrow a) nucleophilic displacement, (arrow b) ring-opening/C₂-hydroxide attack, followed by (arrow c) hydrolysis of the amide

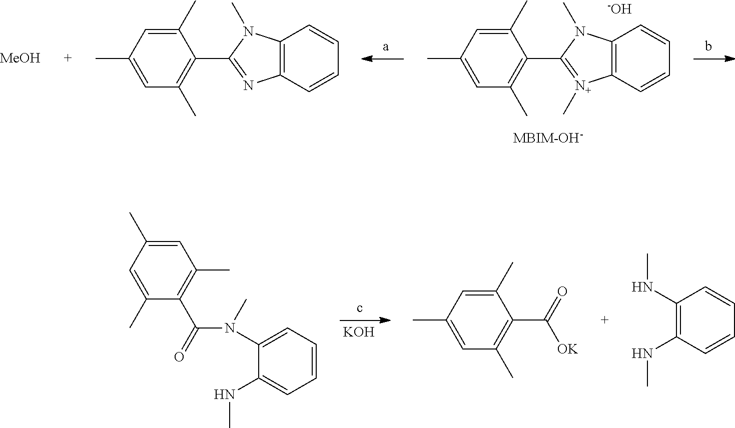

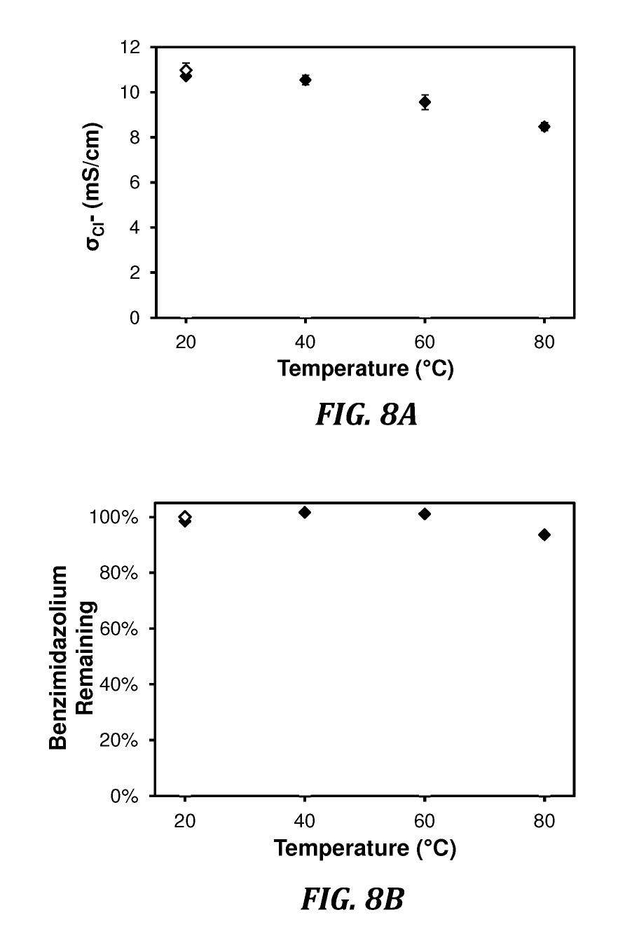

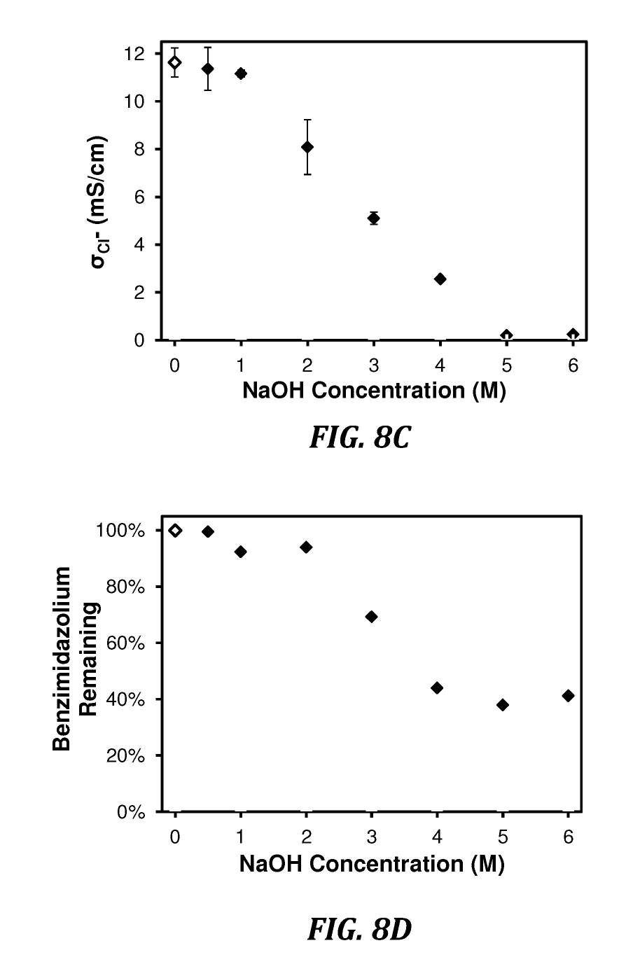

The hydroxide stability of 89% dm HMT-PMBI was examined under high temperature and high pH conditions in order to determine the upper limit of stability. Membranes were first examined for stability in 2 M KOH at 20, 40, 60, and 80° C. for 7 days. The anion conductivity, as shown in FIG. 8A, was stable up to 40° C. but decreased at 60° C. by 9% and at 80° C. by 19%. To determine if the resulting loss in conductivity was due to chemical degradation, the ¹H NMR spectra of each sample was collected. For the spectra of membranes exposed to 2 M KOH at 60° C. and lower, no chemical change was observed. This agrees with a previous literature report wherein HMT-PMBI was subjected to a 2 M KOH, 60° C. test in methanol, and where no degradation was observed after 8 days. The 9% decrease in conductivity is therefore attributed to a morphological change in the membrane, similar to a conditioning process, and no chemical degradation.

Exposure of the membrane to 2 M KOH at 80° C. for 7 days revealed minor changes in the ¹HNMR spectrum of HMT-PMBI, i.e., at 7.2, 5.5-4.6, 3.2-2.6, and 2.4 ppm. Similar to the degradation of MBIM, the peaks shift up-field to similar positions as those for the degraded model compound. In particular, two small peaks emerge in the 5.5-4.6 ppm region, representative of the characteristic N—H group formed by ring-opening degradation. By comparing the integration of the 6.00-4.35 ppm region relative to 12.00H corresponding to the aromatic region, the extent of chemical degradation was quantified using equation (9). In the event that 100% ring opening degradation of the polymer occurred, the 6.00-4.35 ppm should integrate to 2.00H. As such, the remaining quantity of benzimidazolium relative to the initial spectrum can be plotted, as shown in FIG. 8B.

The relative amount of benzimidazolium remaining is unchanged for the 60° C. test, which quantitatively verifies that there is no chemical degradation within this 7 day time period. At 80° C., the amount of benzimidazolium remaining decreases from 100% to 94%. While this 6% degradation may be approach the numeric uncertainty in this method, it appears to be consistent with the qualitative changes observed in the NMR spectra. However, it is unclear whether the 19% decrease in conductivity is solely related to the minor chemical degradation or if it is a combination of chemical degradation and conditioning.

In a modified degradation study, 89% dm HMT-PMBI was immersed in solutions of increasing NaOH concentration at 80° C. for 7 days. The resulting measured conductivities, after reconverting to the chloride form, as well as the percent benzimidazolium remaining (calculated based on ¹H NMR spectra) are shown in FIG. 8C and FIG. 8D, respectively. The conductivity of the membranes exposed to 0.5 M and 1.0 M NaOH at 80° C. did not significantly change over the 7 day period, demonstrating its stability against hydroxide ion attack. However, immersion into solutions above 1 M NaOH results in a decrease in conductivity. ¹H NMR analyses indicated significant degradation is observable (FIG. 8D), where the amount of remaining benzimidazolium reaches a plateau of 40% for the 5.0 and 6.0 M NaOH treatments. This may due to the inability of hydroxide to permeate any further into the increasingly hydrophobic membrane which is induced after degradation. Similar to the prior degradation experiment, 94% benzimidazolium remained for the 2 M NaOH treatment, suggesting that there is no significant difference between 2 M NaOH and 2 M KOH degradation tests at 80° C. for 7 days.

Over the 7 days at 80° C., all membranes subjected to NaOH solutions (0.5 M to 6.0 M) remained intact and flexible. However, the initially yellow-colored membrane became darker in color commensurate with the NaOH concentration. The retention of the physical properties of the membrane suggests ring-opening degradation does not result in extensive backbone cleavage, which would occur if amide hydrolysis continued, as is observed with methylated m-PBI. It can be presumed that the degradation is retarded after ring-opening degradation. The red-shifted color, as was observed with the fully ring-opened model compound, appears to follow the same trend as the percent of remaining benzimidazolium (FIG. 8D), suggesting that this ring-opening degradation is the major, and possibly only, degradation pathway occurring.

When the membrane was subjected to 6 M NaOH at room temperature for 7 days, no chemical degradation was apparent. By using equation 9, the amount of benzimidazolium remaining was calculated to be 98%, which quantitatively implies no significant degradation. Similar to the previously mentioned conditioned process, the membrane that was treated in 6 M NaOH had an increased anionic conductivity from 10.1±0.4 mS cm⁻¹ initially to 12.0±0.4 mS cm⁻¹. This suggests that the material is highly stable in 6 M NaOH at room temperature, representative of exceptional ex situ stability.

In Situ Fuel Cell Operation

The 89% dm HMT-PMBI was used as both the membrane and catalyst layer ionomer for fuel cell analysis. The initial iodide form was first exchanged to the chloride form, as chloride has been shown to have a negligible effect on electrocatalysis in alkaline electrolytes. A rigorous pre-conditioning was invoked to ensure accurate data for long-term stability tests, involving immersion of the chloride form CCM in 1 M KOH for 7 days followed by 7 days in water. Long-term immersion of the hydroxide-form AEMFCs in water removes impurity ions from the catalyst layers, thus improving electrocatalysis and preventing in situ degradation from precipitate formation, potentially leading to improved long-term stability. Few standard practices exist in the characterization of AEMFC membranes and ionomers, and ‘best practices’ are only just beginning to be developed. However, it is possible that beginning-of-life polarization data may only represent polarization data achieved when the membrane/ionomer is in an effectively KOH-doped state. As such long-term polarization steps were chosen (5 min pt⁻¹), which is a standard procedure for the in situ characterization of proton-exchange membrane and ionomer materials. Additionally, this ensures equilibrium is reached in terms of water management, which is a more complex process in AEMFCs than for PEFCs.

The AEMFC for which data are presented (FIG. 2) was conditioned at low potentials, reaching full conditioning, i.e., near-peak power densities, within 8 h.

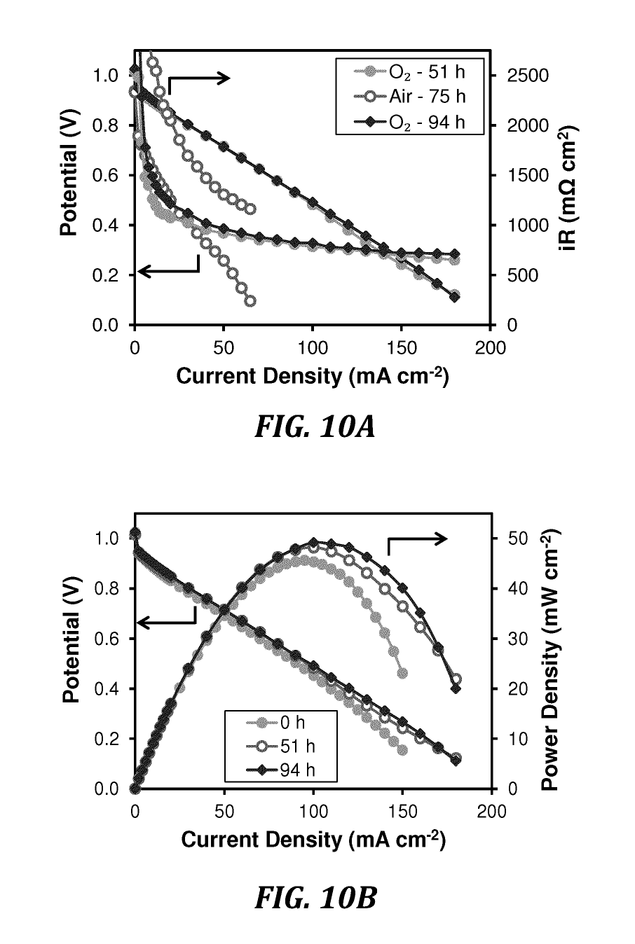

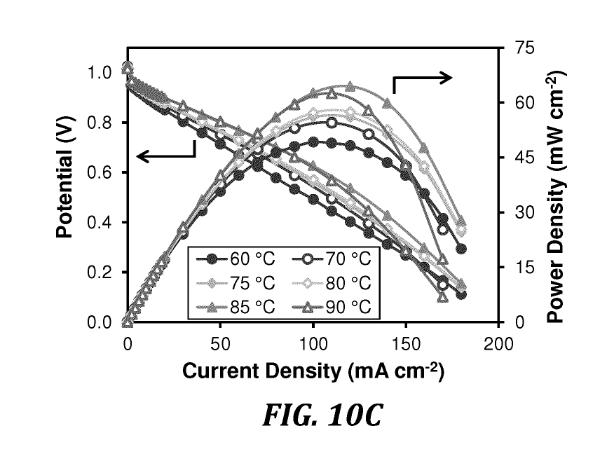

AEMFCs functioned stably at all potentials over dozens of slow polarization curves at 60° C. for over 100 h, as shown in FIG. 9. A cold restart (i.e., shutdown, cool-down, and re-equilibration to full function) was performed, including a 5-day period of non-function at the 60 h mark, which the hours are not included in the following reported lifetime. After full re-equilibration, the cell was operated for 21 h with CO₂-containing air (at 70-91 h). After returning the gas back to O₂, full re-equilibration was quickly achieved, as observed from the polarization data (FIG. 10A). Representative polarization data are given after conditioning, cold restart, and re-equilibration with air. At 0, 51, and 94 h, the maximum power densities (Pₘₐₓ) measured from FIG. 10B are 47.7, 48.9, 49.2 mW cm⁻², respectively, which signifies an improvement over time and is surprising for an AEMFC operating at 60° C. under challenging conditions. Additionally, the absence of hysteresis in this AEMFC from the cold restart and its operation in CO₂-containing air is without published precedent. The long-term improvements to power density and the stable polarization data strongly suggest HMT-PMBI membranes and ionomers are especially stable under these operation conditions.

After operating the fuel cell at 60° C. for 109 h, the temperature was increased up to 90° C. and polarization data were recorded. For 5° C. temperature increments from 70-90° C., Pₘₐₓ values were 54.5, 55.9, 57.4, 64.4, and 62.5 mW cm², respectively (FIG. 10C). The reduction in peak power density between the 85° C. and 90° C. data is attributed to early-onset mass transport losses. The overall peak power density increased 31% between 60 and 85° C., with significant improvements in the kinetic-region for polarization data between 70 and 85° C. Improvements in the high-temperature operation were consistent over multiple fuel cell tests, which is noteworthy for membrane-based alkaline AEMFCs.

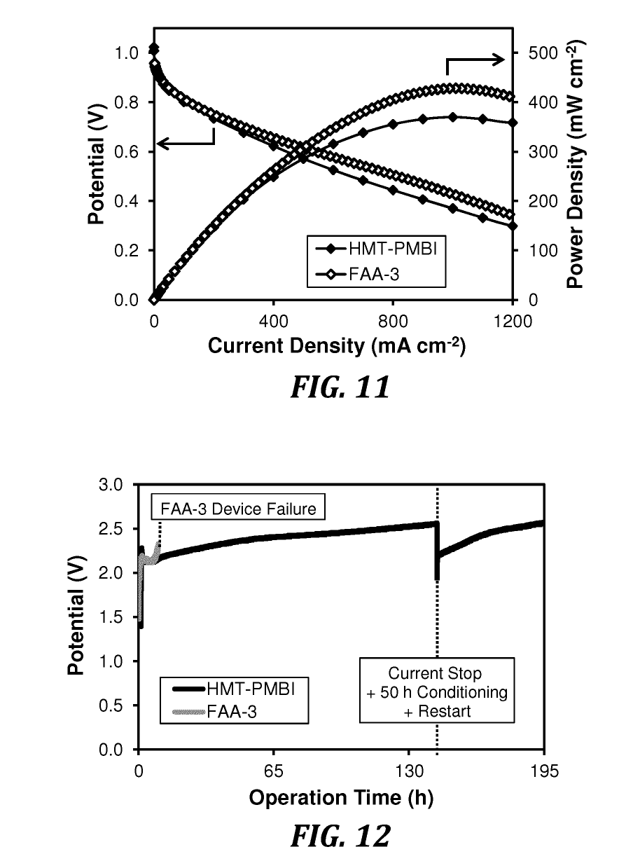

To compare an HMT-PMBI-based fuel cell with that of a commercial-type AEMFC, CCMs were prepared using a FuMA-Tech FAA-3 membranes and ionomer. When the cell containing this commercial membrane and ionomer was subjected to the same pre-conditioning as HMT-PMBI (1 M KOH for 7 days followed by 24 h in water), the AEMFC based on commercial materials was non-operational due to degradation. However, if the commercial fuel cell was first conditioned using a 1 M KOH soak for 24 h and used without a water wash, the cell was fully operational, reaching a Pₘₐₓ of 430 mW cm⁻² after 45 min conditioning, as shown in FIG. 11. HMT-PMBI fuel cells, conditioned by soaking in 1 M KOH for 7 days and 24 h in water, yielded a similar Pₘₐₓ, 370 mW cm⁻². The cells containing the commercial membrane and ionomer could not be subjected to the shutdown, restart, exposure to CO₂-containing air, nor higher temperature without rapid degradation.

In Situ Water Electrolysis Operation

The water electrolyzer setup involved using 1 M KOH as liquid electrolyte at 60° C., which is considered a rigorous test of alkaline stability. Furthermore, the use of dual syringe pumps and atmospheric pressure in the experimental setup (FIG. 3) resulted in constantly switching differential pressure on the membrane as well as significant bubble formation, which causes additional stresses on the membrane. In commercial electrolyzers, these issues are usually addressed by operating with shock-free electrolyte flows and at high pressures, as high as 200 bar. As a result, this experimental setup also serves as an accelerated mechanical stress test under alkaline conditions. In situ lifetimes therefore represent a rigorous measure of mechanical and chemical durability. The measured voltages over time for the commercial (FAA-3) and HMT-PMBI based water electrolyzer cells are shown in FIG. 12.

Under these conditions, in the example used to demonstrate the stability of HMT-PDMBI cells, the cell based on commercial materials became inoperable after 9.5 h at 20 mA cm⁻². During the 9.5 h, the average potential was 2.16±0.04 V. End-of-life was represented by the absence of gas evolution and a substantial drop in potential (below 1.23 V), which is believed to result from membrane degradation and electrical shorting. The relatively short lifetime of the commercial material under these conditions was reproducible, and repeated on individual cells, 11 times. The average operational time of three cells prepared using FAA-3 membranes was 16.2 h.

In contrast, water electrolyzers fabricated from HMT-PMBI were be operable at 25 mA cm⁻² for >144 h, with an overall applied potential of 2.4±0.1 V (this voltage is a typical applied potential for AEM electrolysis). HMT-PMBI cells demonstrated improving performance compared to the commercial cell. Operation of the cell was stopped after 144 h for evaluation, during which electrolyte flows and temperature were maintained. In the example shown, the cell was stopped for 50 h before restarting, and electrolysis continued for an additional 51 h at a potential 2.4±0.1 V, whereupon the still-operational cell was shut down. The total time in situ was 245 h, representing a minimum of >20 times longevity versus a benchmark commercial membrane. The observed re-conditioning between the two periods of operation suggests that the catalyst was subject to poisoning from feed water impurities rather than material degradation, as trace impurities have been shown to strongly affect the HER.

The feasibility of scaled-up preparation of HMT-PMBI was demonstrated through the synthesis of 617 g of high purity polymer in 42±3% overall yield. Each step was synthetically improved and shown to be highly reproducible; a synthetic step was eliminated. The HMT-PMBI dimethylated to 89% and cast as membranes were exceptionally strong and flexible when dry, as demonstrated through the measured tensile strength, elongation at break, and Young's modulus. In their fully hydrated chloride form, the mechanical properties were superior to commercial Nafion 212 membrane, which is remarkable in the context of AEMs given that membranes were cast from solvents and contained no additives or subjected to cross-linking. A wide range of properties, including dimensional swelling, water uptake, and conductivity for various ion forms is presented. The activation energy for the ionic conductivity of HMT-PMBI in mixed hydroxide/bicarbonate form in air was constant above 60% RH but increased when the RH was reduced to <60% RH.

Ex situ stability tests demonstrated the exceptional stability of HMT-PMBI under various hydroxide concentrations and temperatures; for example, no significant degradation in 1 M NaOH at 80° C. or 6 M NaOH at room temperature was observed after 168 h. HMT-PMBI was examined for in situ stability as the membrane and ionomer in an AEMFC and water electrolyzer. For the AEMFC at 60° C., the polymer demonstrated >100 h of operation at various current densities, which improved during operation, despite modulating the cathode feed between pure O₂ and CO₂-containing air and the first reported fully-restored restart of an AEMFC. AEMFCs based on the material achieved high power densities of 370 mW cm⁻², comparable to commercial AEMFCs. However, HMT-PMBI cells demonstrated increased material stability, resulting in substantially more stable operation and longer lifetimes. For example, in water electrolyzers, an HMT-PMBI-based cell, using 1 M KOH electrolyte at 60° C., was operated for 195 h without any drop in performance, whereas comparable cells based on the commercial materials became inoperable after only 16 h.

Collectively, the in situ and ex situ stability of HMT-PMBI, together with its ease of synthesis, mechanical properties, solubility in selective solvents, and insolubility in water make it a benchmark alkaline anion-exchange membrane and ionomer, providing motivation to further study in a wide range of energy applications, e.g., redox flow and metal-air batteries. Additionally, access to a versatile and useable hydroxide-conducting polymer will facilitate further research into AEMFCs and water electrolyzers, including the investigation of novel catalysts, effects of CO₂, and impact of free radical formation on the lifetime of AEMFCs and electrolyzers.

### Example 2. Tri-Doped Reduced Graphene Oxide as a Metal-Free Catalyst for Polymer Electrolyte Fuel Cells

Polymer electrolyte fuel cells (PEFCs) based on hydrogen oxidation and oxygen reduction are considered a promising technology for emission-free energy conversion. Metal-free heteroatom-doped carbon materials, such as doped graphene and carbon nanotubes (CNTs) or mesoporous carbons, which have with a two dimensional structure, high electron mobility, and large specific surface area, can be used as oxygen reduction reaction (ORR) catalysts. For example, reduced graphene oxide (rGO) can be co-doped with nitrogen and fluorine, resulting in a higher catalytic activity when compared to the respective individually N- and F-doped materials. Without wishing to be bound by theory, it is believed that a combination of dopants can provide a relatively larger number of active sites when compared to individually doped graphene-based materials.

Tri-doped reduced graphene oxide with F, N and S as doping species was synthesized, with the expectation that it will exhibit an even higher catalytic activity. F- and N-doping leads to charge polarization via C—F and C—N bonds, and S-doping creates unpaired electrons at the defect sites in the vicinity of C—S bonds, generating both types of active sites. The F, N and S tri-doped reduced graphene oxide (F,N,S-rGO) was synthesized by annealing a composite of sulfur-doped reduced graphene oxide (S-rGO), Nafion and dimethyl formamide (DMF) under N₂ atmosphere at 600° C. Nafion and DMF serve as F and N sources, respectively. The novel tri-doped rGO was characterized by energy-dispersive X-ray spectroscopy (EDX), Fourier transform infrared spectroscopy (FT-IR), and X-ray photoelectron spectroscopy (XPS). The results show that S-rGO is fluorinated by F^{●} radicals or F-containing radicals, as well as N^{●} radicals, generated by the pyrolysis of Nafion and DMF, respectively. The catalytic activity towards the ORR of F,N,S-rGO was characterized by rotating disk electrode measurements (RDE) and by its incorporation into AEMFCs as cathode catalyst layers. Maximum power densities of 46 mW/cm² were obtained for AEMFCs including HMT-PMBI, at a cell temperature of 85° C., using oxygen and hydrogen fuels under 300 kPa absolute pressure and a temperature of 83° C. The F,N,S-rGO ORR catalyst is cost-effective and exhibits high stability under fuel cell operating conditions.

Material Characterizations

rGO was first sulfur-doped, then used as precursor for the synthesis of F,N,S-rGO. Graphene oxide (GO) was refluxed with phosphorus pentasulfide (P₄S₁₀) whereupon oxygen atoms within GO were partially replaced by sulfur and simultaneously reduced to form S-rGO. S-rGO also contains thiol groups, which enables it to be soluble in various solvents, facilitating the next steps of the synthesis. To remove metal impurities existing in the samples, GO (obtained via Hummer's method) was extensively purified. EPR measurements confirmed that manganese, the only metal involved in this synthesis, had been completely removed after refluxing. For the synthesis of F,N,S-rGO, DMF containing S-rGO and Nafion were dispersed in dimethyl formamide (DMF) under ultrasonication to yield a homogeneous dispersion. After evaporation of solvents by heating at 100° C., a composite of S-rGO-Nafion-DMF was obtained. Subsequently, the S-rGO-Nafion-DMF composite was annealed at 600° C. under N₂ to provide F,N,S-rGO powder.

The morphology of the F,N,S-rGO powder provides a high surface area (BET model) of 575 m²/g, which facilitates the oxygen diffusion to the active centers when used as cathode catalyst in a AEMFCs. EDX elemental mappings of the material at different magnifications demonstrate a homogeneous distribution of F-, N-, and S-doping across the graphene sheets. According to the XPS data, the atomic concentrations of doping elements are 1.19, 2.01, and 1.06 at % for fluorine, nitrogen, and sulfur,

Electrochemical Characterizations

Electrochemical investigation for ORR catalysis of F,N,S-rGO was performed in both 0.1M HClO₄ and 0.1M NaOH. While no reduction peak is observed under N₂ saturation, the cyclic voltammetry (CV) of F,N,S-rGO in 0.1M NaOH at a scan rate of 20 mV/s shows the typical O₂ reduction peaks at ˜0.75 V vs RHE under O₂-saturation, thus demonstrating the ORR catalytic activity of F,N,S-rGO. Linear sweep voltammetry (LSV) curves of F,N,S-rGO, S-rGO, GO, glassy carbon, and benchmark Pt/C in O₂-saturated 0.1M NaOH at electrode rotating speed of 1600 rpm reveal an increase of catalytic activity from GO to S-rGO to F,N,S-rGO, as demonstrated by the reduced onset potential and increased current density. The F,N,S-rGO exhibits an even higher catalytic activity with the most positive onset potential of 0.85 V (vs. RHE) and the highest limiting current density of ˜3.5 mA/cm² among the four carbon based materials.

Incorporation into AEMFCs

In situ ORR performance of F,N,S-rGO in an AEMFC was evaluated. The F,N,S-rGO based cathodes were fabricated by spray-coating the catalyst ink on top of a 5 cm² commercial carbon-fiber GDL (F,N,S-rGO-SG). For the AEMFC, HMT-PMBI was used. Membrane electrode assemblies (MEAs) were constructed by stacking the F,N,S-rGO-SG cathodes with an electrolyte membrane and a Pt—C gas diffusion anode (0.2 mg Pt/cm² on Sigracet 25BC). The fuel cell polarizations and power density curves for the AEMFC using F,N,S-rGO as cathode materials were measured. The superior performance in alkaline electrolyte that was observable in RDE measurements is well reflected when F,N,S-rGO is incorporated into full AEMFCs. The AEMFC manifests a peak power density of 46 mW/cm².

A fuel cell with exclusively S-doped rGO as catalyst but otherwise the same specifications as the acidic F,N,S-rGO sample was also constructed. This fuel cell exhibited a much lower peak power density of 5.8 mW/cm², showing the synergistic effect of the F, N, and S tri-doping compared to individual S-doping.

The heteroatom-doped graphene-based materials have been shown to be less susceptible to many cathode degradation mechanisms, such as high radical concentrations caused by fuel crossover, and is less susceptible to CO poisoning than Pt catalysts.

Synthesis of S-rGO

Materials: HPLC reagent grade dimethylformaminde (DMF), phosphorus pentasulfide (P₄S₁₀) (99%) and 0.2 μm polyamide filter membrane were purchased from Scharlau Chemie S.A, Sigma Aldrich and Whatman INT.Ltd, respectively. GO was synthesized using a modified Hummer's method (see SI). S-rGO was prepared according to our previous report. In brief, 100 mg GO was dispersed in 100 ml DMF and sonicated for 1 h. After removing undispersed GO by centrifugation at 1000 rpm for 10 min, a homogeneous solution of GO in DMF was obtained. Then, 300 mg P₄S₁₀ was added to the solution. The reaction flask was evacuated to 5.10⁻³ mbar at 100° C. for 2 min to remove humidity in the flask atmosphere and refused with N₂, this step was repeated 3 times. The thionation was performed for 24 h in nitrogen atmosphere under continuous stirring at 140° C. Finally, the reaction product was collected by filtering the solution through a 0.2 μm polyamide membrane filter and was extensively washed in succession with 100 ml of water, ethanol and DMF, respectively.

F,N,S-rGO Synthesis

2 g of DMF-saturated S-rGO (200 mg S-rGO containing 800 mg DMF) and 1 ml Nafion dispersion (D2021 Nafion dispersion, Dupont) were mixed with 2 ml DMF by stirring for 10 min at room temperature. The dispersion was then performed by an ultrasonication step for 10 min. A homogeneous S-rGO-Nafion-DMF dispersion was obtained as result. Consequently, the dispersion was heated on a hotplate at 100° C. for 10 min to evaporate residual solvent. A certain amount of DMF remained in the S-rGO-Nafion composite due to reaction of DMF with Nafion to form DMF-Nafion salt compound. As a result, a S-rGO-Nafion-DMF composite was achieved. Finally, the S-rGO-Nafion-DMF composite was pyrolyzed at 600° C. for 2 h under nitrogen atmosphere protection using a tubular thermal furnace. As a result, F,N,S-rGO material was achieved.

Fuel Cell Assembly and Characterization

F,N,S-rGO was ground into fine powders, and dispersed in a mixture of solvents consisting of methanol: water: isopropanol (3:1:0.1 mass ratio) containing 15 wt % polymer electrolyte, forming the catalyst ink. The F,N,S-rGO based cathodes were fabricated by spray-coated the catalyst ink on top of a 5 cm² commercial carbon-fiber GDL. Poly(benzimidazolium), HMT-PMBI, was used as membrane and catalyst layer polymer electrolyte. MEAs were assembled by including an anode GDE comprised of 15 wt % HMT-PMBI ionomer on Sigracet 25BC. The polarization and power density data were recorded using a Scribner Associates Inc. 850e test-bench. 300 kPa_{abs} pressurized H₂ and O₂ at a flow rate of 0.5 L/min were used. Polarization data was recorded with a scan speed of 1 min/point.

While illustrative embodiments have been illustrated and described, it will be appreciated that various changes can be made therein without departing from the spirit and scope of the disclosure.

1. A catalyst-coated membrane, comprising:
(a) a film comprising a random copolymer of Formula (I) 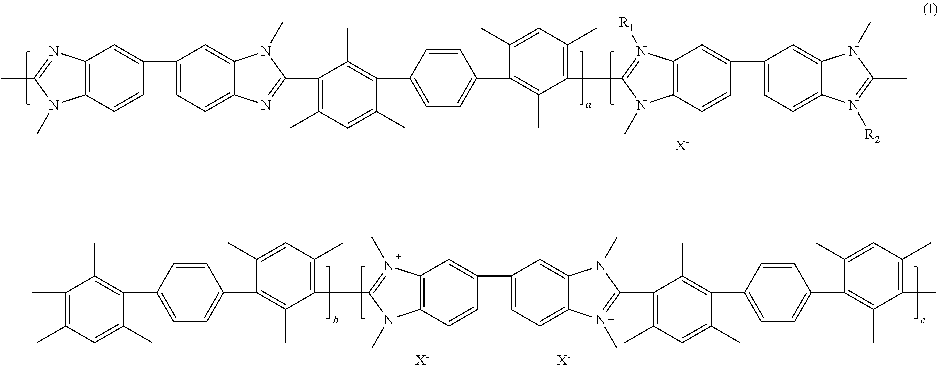
wherein
X is an anion selected from iodide, bromide, chloride, fluoride, hydroxide, carbonate, bicarbonate, sulfate, tetrakis(3,5-bis(trifluoromethyl)phenyl)borate, bis(trifluoromethane)sulfonamide, and any combination thereof, wherein X counterbalances a positive charge in the polymer;
R₁ and R₂ are each independently selected from absent and methyl,
provided that R₁ and R₂ are not both absent, or both methyl;
provided that when one of R₁ or R₂ is methyl, the other is absent; and
provided that when R₁ or R₂ is methyl, the nitrogen to which the methyl is connected to is positively charged,
a, b, and c are mole percentages, wherein
a is from 0 mole % to 45 mole %,
b+c is 55 mole % to 100 mole %,
b and c are each more than 0%, and
a+b+c=100%, and
(b) a catalyst coating on the film, the catalyst coating comprising from 5% to 35% by weight of the polymer of Formula (I) and from 65% to 95% by weight of a metal or non-metal catalyst.

2. The catalyst-coated membrane of claim 1, wherein the polymer of Formula (I) comprises from 80% to 95% degree of methylation.

3. The catalyst-coated membrane of claim 1, wherein the polymer of Formula (I) comprises from 85% to 95% degree of methylation.

4. The catalyst-coated membrane of any one of the preceding claims, wherein the catalyst coating comprises from 10% to 30% by weight of the polymer of Formula (I).

5. The catalyst-coated membrane of any one of the preceding claims, wherein the catalyst coating comprises from 11% to 65% by weight of the metal or non-metal catalyst.

6. The catalyst-coated membrane of any one of the preceding claims, wherein the metal catalyst is selected from carbon-supported Pt, alkaline-stable metal-supported Pt, non-supported Pt, carbon-supported Pt alloy, alkaline-stable metal-supported Pt alloy, non-supported Pt alloy, and any combination thereof.

7. The catalyst-coated membrane of claim 6, wherein the alkaline-stable metal-supported Pt is selected from Sn-supported Pt, Ti-supported Pt, Ni-supported Pt, and any combination thereof; and the alkaline-stable metal-supported Pt alloy is selected from Sn-supported Pt alloy, Ti-supported Pt alloy, Ni-supported Pt alloy, and any combination thereof.

8. The catalyst-coated membrane of claim 6, wherein the carbon-supported Pt comprises from 20% by weight to 50% by weight of Pt.

9. The catalyst-coated membrane of any one of claims 1 to 5, wherein the metal catalyst is selected from supported Pt black and non-supported Pt black.

10. The catalyst-coated membrane of claim 6, wherein the Pt alloy is selected from a Pt—Ru alloy, a Pt—Ir alloy, and a Pt—Pd alloy.

11. The catalyst-coated membrane of any one of claims 1 to 5, wherein the metal catalyst is selected from Ag, Ni, alloys thereof, and any combination thereof.

12. The catalyst-coated membrane of any one of claims 1 to 5, wherein the non-metal catalyst is a doped graphene.

13. The catalyst-coated membrane of claim 12, wherein the graphene is doped with S, N, F, a metal, or a combination thereof.

14. The catalyst-coated membrane of any one of claims 1 to 5, wherein the non-metal catalyst is a doped carbon nanotube.

15. The catalyst-coated membrane of claim 14, wherein the carbon nanotube is doped with S, N, F, a metal, or a combination thereof.

16. The catalyst-coated membrane of any one of the preceding claims, wherein the membrane undergoes less than 5% ring opening degradation, as determined by proton NMR spectroscopic analysis, when subjected to an aqueous solution comprising from 1 M to 6 M hydroxide at room temperature for at least 168 hours.

17. A fuel cell, comprising a catalyst-coated membrane of any one of the preceding claims, wherein the catalyst-coated membrane has two sides, and one side of the catalyst-coated membrane is a cathode, and the other side of the catalyst-coated membrane is an anode.

18. The fuel cell of claim 17, wherein the catalyst-coated membrane is a pre-conditioned catalyst-coated membrane.

19. The fuel cell of claim 18, wherein the pre-conditioned catalyst-coated membrane is obtained by immersing the catalyst-coated membrane in a 1 M to 2 M aqueous hydroxide solution for 1 to 24 hours.

20. The fuel cell of any one of claims 17 to 19, wherein the catalyst-coated membrane comprises a random copolymer of Formula (I), wherein X is an anion selected from iodide, bromide, chloride, fluoride, and any combination thereof; and after immersing the catalyst-coated membrane in a 1 M to 2 M aqueous hydroxide solution for 1 to 24 hours, X is exchanged for an anion selected from hydroxide, carbonate, bicarbonate, and any combination thereof.

21. The fuel cell of any one of claims 17 to 20, wherein the catalyst-coated membrane comprises a cathode catalyst loading of 0.1 mg to 5.0 mg of a metal or non-metal catalyst per cm² and an anode catalyst loading of 0.1 mg to 5.0 mg of a metal or non-metal catalyst per cm².

22. The fuel cell of any one of claims 17 to 20, wherein the catalyst-coated membrane comprises a cathode catalyst loading of 0.1 mg to 0.5 mg of a metal or non-metal catalyst per cm² and an anode catalyst loading of 0.1 mg to 0.5 mg of a metal or non-metal catalyst per cm².

23. The fuel cell of any one of claims 17 to 22, wherein the fuel cell is capable of operating at a power density of 20 mW/cm² or more, at 60° C. to 90° C., for more than 4 days.

24. The fuel cell of any one of claims 17 to 22, wherein the fuel cell is capable of operating at a power density of 25 mW/cm² or more, at 60° C. to 90° C., for more than 4 days.

25. The fuel cell of any one of claims 17 to 24, wherein when the fuel cell is shut down after a period of operation and restarted, the fuel cell is capable operating with a decrease of 5% or less in power density within 6 hours of restarting.

26. The fuel cell of any one of claims 17 to 25, wherein the fuel cell is operated in an atmosphere comprising carbon dioxide, oxygen, and water at the cathode.

27. The fuel cell of any one of claims 17 to 25, wherein the fuel cell is operated in an oxygen and water atmosphere at the cathode.

28. The fuel cell of any one of claims 17 to 25, wherein the fuel cell is operated in a carbon dioxide-free atmosphere at the cathode.

29. The fuel cell of any one of claims 17 to 28, wherein the fuel cell is operated in a hydrogen atmosphere at the anode.

30. The fuel cell of any one of claims 17 to 28, wherein the fuel cell is operated in an atmosphere comprising methanol, ethanol, hydrazine, formaldehyde, ethylene glycol, or any combination thereof at the anode.

31. A method of operating a fuel cell according to any one of claims 17 to 30, comprising:
(a) conditioning the fuel cell by supplying hydrogen to the anode, and oxygen and water to the cathode, and operating the fuel cell to generate electrical power and water at a potential of 1.1 V to 0.1 V and at a temperature of 20° C. to 90° C., until the fuel cell reaches at least 90% of peak performance; and
(b) continuing supplying hydrogen to the anode and oxygen and water to the cathode, and operating the fuel cell at a potential of 1.1 V to 0.1 V and a temperature of 20° C. to 90° C.

32. The method of claim 31, wherein step (b) comprises operating the fuel cell at a potential of 0.6 V to 0.4 V.

33. The method of claim 31, wherein step (b) comprises operating the fuel cell at a potential of 0.8 V to 0.6 V.

34. The method of any one of claims 31 to 33, wherein the catalyst-coated membrane is treated with aqueous hydroxide prior to conditioning the fuel cell.

35. The method of any one of claims 31 to 34, wherein the catalyst-coated membrane is exposed to carbon dioxide prior to conditioning the fuel cell.

36. The method of any one of claims 31 to 35, wherein the maximum power density increases during operation of the fuel cell.

37. The method of any one of claims 31 to 36, further comprising:
(c) stopping the supply of hydrogen to the anode and oxygen and water to the cathode to stop operation of the fuel cell;
(d) cooling the fuel cell to below 40° C.; and
(e) reconditioning the fuel cell by supplying hydrogen to the anode, and oxygen and water to the cathode, and operating the fuel cell to generate electrical power and water at a potential of 1.1 V to 0.1V and at a temperature of 20° C. to 90° C.

38. The method of any one of claims 31 to 37, wherein supplying oxygen to the cathode comprises supplying a mixture of oxygen, carbon dioxide, and water to the cathode.

39. The method of claim 37 or 38, wherein the fuel cell has a performance that decreases by less than 5% in power density or increases by less than 5% in total resistance within 6 hours of reconditioning the fuel cell,
wherein the performance is determined by a total resistance in an Ohmic region measured using a current-interrupt method, a high-frequency resistance method, or both, and/or
wherein the performance is determined by a peak power density in polarization data measured by increasing current from open circuit at set intervals of 20-200 mA/cm² at a time of 1 minute or more per point.

40. The method of any one of claims 31 to 39, further comprising operating the fuel cell at a temperature of 20° C. to 90° C., wherein the fuel cell has a power density of greater than 25 mW/cm².

41. A method of making a fuel cell, comprising
(a) pre-conditioning a catalyst-coated membrane of any one of claims 1 to 16 by contacting the catalyst-coated membrane with an aqueous hydroxide solution for at least 1 hour to provide a pre-conditioned catalyst-coated membrane; and
(b) incorporating the pre-conditioned catalyst-coated membrane into a fuel cell.

42. A method of making a fuel cell, comprising
(a) incorporating a catalyst-coated membrane of any one of claims 1 to 16 into a fuel cell; and
(b) pre-conditioning the fuel cell by contacting the catalyst-coated membrane with an aqueous hydroxide solution for at least 1 hour to provide a pre-conditioned catalyst-coated membrane.

43. The method of claim 41 or claim 42, wherein contacting the catalyst-coated membrane with an aqueous hydroxide solution is followed by contacting the catalyst-coated membrane with water for at least 1 day.

44. A water electrolyzer, comprising a catalyst-coated membrane of any one of claims 1 to 16, wherein the catalyst-coated membrane has two sides, and one side of the catalyst-coated membrane is a cathode, and the other side of the catalyst-coated membrane is an anode.

45. The water electrolyzer of claim 44, wherein the catalyst-coated membrane comprises a cathode catalyst loading of 0.1 mg to 5.0 mg metal or non-metal catalyst per cm² and an anode catalyst loading of 0.1 mg to 5.0 mg metal or non-metal catalyst per cm².

46. The water electrolyzer of claim 44, wherein the catalyst-coated membrane comprises a cathode catalyst loading of 1.0 mg to 5.0 mg metal or non-metal catalyst per cm² and an anode catalyst loading of 1.0 mg to 5.0 mg metal or non-metal catalyst per cm².

47. The water electrolyzer of any one of claims 44 to 46, wherein the electrolyzer is capable of being operated at 25 mA/cm² or more for 144 hours or more, at an overall applied potential of 1.6 V or more.

48. The water electrolyzer of any one of claims 44 to 47, wherein the water electrolyzer is capable of being operated at a pressure at the cathode of up to 30 bar and a pressure at the anode of up to 30 bar, wherein the pressure at the cathode and the pressure at the anode are the same or different.

49. The water electrolyzer of any one of claims 44 to 48, wherein when the water electrolyzer is shut down after a period of operation and restarted, the water electrolyzer is capable of operating with less than a 5% increase in potential at a current density achieved within 6 hours of restarting the water electrolyzer.

50. A method of operating a water electrolyzer of any one of claims 44 to 49, comprising:
(a) providing water or an aqueous hydroxide electrolyte solution at 20° C. to 80° C. to the anode, the cathode, or both the anode and the cathode of the water electrolyzer; and
(b) operating the water electrolyzer to generate hydrogen, oxygen, and water.

51. The method of claim 50, wherein water or the aqueous hydroxide electrolyte solution is provided alternately to the cathode and the anode.

52. The method of claim 50 or 51, further comprising pre-conditioning the electrolyzer by contacting the catalyst-coated membrane with an aqueous hydroxide solution for at least 1 hour, prior to step (a).

53. A method of making an electrolyzer, comprising
(a) incorporating a catalyst-coated membrane of any one of claims 1 to 16 into the electrolyzer; and
(b) pre-conditioning the electrolyzer by contacting the catalyst-coated membrane with an aqueous hydroxide solution for at least 1 hour to provide a pre-conditioned catalyst-coated membrane.

54. A method of making an electrolyzer, comprising
(a) pre-conditioning a catalyst-coated membrane of any one of claims 1 to 16 by contacting the catalyst-coated membrane with an aqueous hydroxide solution for at least 1 hour to provide a pre-conditioned catalyst-coated membrane; and
(b) incorporating the pre-conditioned catalyst-coated membrane into an electrolyzer.

55. The method of claim 53 or claim 54, wherein contacting the catalyst-coated membrane with an aqueous hydroxide solution is followed by contacting the catalyst-coated membrane with water for at least 7 days.
